(19) United States
(12) Patent Application Publication
(10) Pub. No.: US 2026/0308485 A1
(43) Pub. Date: Oct. 8, 2026

(54) Surfactants for Disinfectant and Laundry Compositions

(71) Applicant: ARXADA, LLC, Morristown, NJ (US)

(72) Inventors: Jordan Todorov Petkov, Castleford, West Yorkshire (GB); Philip Roebuck, Castleford, West Yorkshire (GB); Thomas Pointon, Castleford, West Yorkshire (GB); Leo Poorvin, Morristown, NJ (US); James Folsom, Morristown, NJ (US); David Binder, Morristown, NJ (US)

(21) Appl. No.: 19/483,267

(22) PCT Filed: Jun. 18, 2024
(86) PCT No.: PCT/US2024/034496

§ 371 Date: Nov. 11, 2025

Related U.S. Application Data
(60) Provisional application No. 63/509,878, filed on Jun. 23, 2023.

(51) Int. Cl. C11D 3/48; C11D 1/72; C11D 1/835

(52) U.S. Cl. CPC C11D 3/48; C11D 1/72; C11D 1/835; C11D 2111/12

(57) ABSTRACT

Provided herein are compositions containing at least one antimicrobial agent combined with at least one surfactant. The surfactant can be an alkoxylated surfactant. In one aspect, the surfactant is an ethoxylated quaternary amine. In another aspect, the surfactant is an ethoxylated tertiary amine. In still another aspect the surfactant is a mixture of an ethoxylated tertiary amine and an ethoxylated quaternary amine. The composition can be a fabric treatment, such as a laundry detergent.

### CROSS REFERENCE TO RELATED APPLICATIONS

This application claims priority to the benefit of U.S. Provisional Application No. 63/509,878, filed Jun. 23, 2023, which is expressly incorporated herein by reference in its entirety.

### BACKGROUND

Pathogenic organisms, such as bacteria, fungi, and viruses, continue to cause infections in humans as well as domestic animals and pets. Disinfectant formulations have been developed over the last several decades to reduce or destroy pathogenic organisms and accordingly, reduce the rate of infection. Literally any soft or hard surface including floors, walls, countertops, fabrics, textiles, windows, windowsills, sinks, faucets, waste containers, appliances, and cabinet surfaces can become contaminated and pose a transmission risk to those that come into contact with these surfaces. Disinfectants have been developed to treat surfaces for use in hospitals, rest homes, schools, and homes.

A disinfectant refers to any chemical agent capable of killing, destroying, or inhibiting the growth of organisms, particularly microorganisms. Disinfectant products include hard surface cleaners, soft surface cleaners (e.g. fabric treatments), hand sanitizers, sterilizing compositions, and the like. Antimicrobial compositions for decontamination, disinfection and/or sanitization can also be added to wipes in order to treat such surfaces.

Ideally, a disinfectant has broad-spectrum activity against all types of microorganisms at various pH levels. The disinfectant should also have high efficacy so that a minimum amount of the antimicrobial agent can be used to save cost and to avoid or reduce any possible adverse effects caused by the antimicrobial agent. Also, it is desirable that the disinfectant is stable to any changes in temperature encountered during manufacturing, packaging, and shipping as well as during storage. Further, an ideal disinfectant is physically and chemically compatible with ingredients of different application systems so that the antimicrobial agent can suitably be incorporated in various products.

In the past, various different disinfectants have been suggested. For example, disinfectants that have been used in the past include alcohols such as isopropyl alcohol and ethanol, copper compounds, silver compounds, aldehydes, oxidizing agents such as sodium hypochlorite, quaternary ammonium compounds, and the like.

One reoccurring problem in formulating disinfectant compositions is the ability to combine a disinfectant with a surfactant in a manner that enhances the dispersibility of the disinfectant in water, and/or enhances the wetting properties of the composition without adversely interfering with the efficacy of the disinfectant. Surfactants are also added for improving the cleaning efficacy of the composition. However, when a surfactant is combined with some disinfectants, the concentration of the disinfectant has to be increased in order to counteract the negative effects of the surfactant with respect to antimicrobial action. The above drawbacks can become particularly problematic when the disinfectant compositions are incorporated into fabric treatments, such as laundry detergents. For example, laundry detergents typically contain anionic or nonionic surfactants that can adversely interfere with the incorporation of disinfectants into the laundry detergent.

Thus, a need currently exists for improved disinfectant compositions containing surfactants. A need also exists for products that both effectively clean and disinfect.

A need also exists for a fabric treatment, such as a laundry detergent, that contains a surfactant, that is not only well suited to cleaning fabrics but is also compatible with disinfectants. A need also exists for a surfactant that can be incorporated into fabric treatments that is also compatible with other surfactants contained in the composition.

### SUMMARY

In general, the present disclosure is directed to a composition containing one or more surfactants. The surfactants can lower the surface tension and increase the wetting properties of the composition. One or more surfactants are selected in accordance with the present disclosure that can also significantly improve the cleaning properties of the composition without interfering with the efficacy of one or more antimicrobial agents. In fact, in one embodiment, the surfactant can actually enhance the antimicrobial activity of the composition. The one or more surfactants in accordance with the present disclosure can be incorporated into various different types of compositions. The composition, for instance, can be a hard surface cleaner/disinfectant or can be a fabric treatment, such as a laundry detergent.

In one embodiment, the present disclosure is directed to a composition comprising an antimicrobial agent and one or more surfactants combined with the antimicrobial agent. The one or more surfactants comprising:
an ethoxylated tertiary amine of the general formula (I):

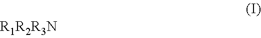

an ethoxylated quaternary amine of the general formula (II):

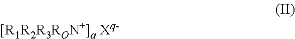

or mixtures thereof,
wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHRₐ—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group, or a CH₂OH group and p is 0 or 1,
X is a counterion selected from the group consisting of species generated from a mineral acid or organic acid, and
q is 1, 2, 3 or 4.

In one aspect, p is 0, and Rₐ, R_{b}, R_{c}, R_{d}, Rₑ, and R_{f} are hydrogen.

In one aspect, R₁ comprises greater than 70%, such as greater than about 80%, such as greater than about 90% of an unsubstituted C18 hydrocarbon.

In one aspect, R1 comprises less than 20% of hydrocarbons having a carbon chain length of 16 carbon atoms or less, comprises from about 80% to about 95% of an unsubstituted C18 hydrocarbon, and comprises less than 5% of hydrocarbons having a carbon chain length of greater than 18 carbon atoms.

In another aspect, R₁ comprises from about 40% to about 65% of an unsubstituted C12 hydrocarbon, comprises from about 10% to about 25% of an unsubstituted C14 hydrocarbon, comprises from about 5% to about 18% of an unsubstituted C16 hydrocarbon, comprises from about 4% to about 15% of an unsubstituted C18 hydrocarbon, comprises from about 1% to about 10% of an unsubstituted C10 hydrocarbon, and comprises from about 0% to about 8% of an unsubstituted C8 hydrocarbon. Each hydrocarbon above can be saturated, unsaturated, or a mixture of saturated and unsaturated hydrocarbons. In one embodiment, the C18 hydrocarbon comprises 1% to 5% of a saturated and 4% to 8% of an unsaturated. Alternatively, the C18 hydrocarbon is comprised entirely of a saturated.

In the formulas above, n+m equals the total mols of R₂ and R₃ groups, such as the total mols of ethoxylate groups of R₂ and R₃ groups. As used herein, the total mols of ethoxylate groups of R₂ and R₃ groups is an average and can be calculated based on the reactants used to produce the molecules or can be determined using NMR spectroscopy.

In one aspect, the composition only contains one or more ethoxylated quaternary amines of the general formula (II). In another aspect, the composition only contains one or more ethoxylated tertiary amines of the general formula (I). In still another embodiment, the surfactant composition comprises a mixture of an ethoxylated quaternary amine of the general formula (II) and an ethoxylated tertiary amine of the general formula (I). In one aspect, for instance, the mixture can comprise from about 5% by weight to about 80% by weight of at least one ethoxylated quaternary amine and from about 95% by weight to about 20% by weight of at least one ethoxylated tertiary amine. For instance, the mixture can comprise from about 5% by weight to about 35% by weight of at least one ethoxylated quaternary amine and from about 95% by weight to about 65% by weight of at least one ethoxylated tertiary amine.

In one embodiment, the surfactant comprises a quaternary ethoxylated fatty amine. In another embodiment, the surfactant comprises a tertiary ethoxylated fatty amine. In still another embodiment, the surfactant comprises a mixture of a tertiary ethoxylated fatty amine and a quaternary ethoxylated fatty amine. Particular embodiments of the surfactant or mixture of surfactants include a quaternary ethoxylated stearyl-2-hydroxyethylamine, chloride containing from about 8 mols to about 30 mols of ethoxylate; a tertiary ethoxylated stearyl-2-hydroxyethylamine containing from about 8 mol to about 30 mol of ethoxylate; a mixture of quaternary ethoxylated stearyl-2-hydroxyethylamine, chloride containing from about 8 mols to about 30 mols of ethoxylate and of a tertiary ethoxylated stearyl-2-hydroxyethylamine containing from about 8 mol to about 30 mol of ethoxylate; a quaternary ethoxylated cocoalkyl-2-hydroxyethylamine, chloride containing from about 8 mols to about 30 mols of ethoxylate; a tertiary ethoxylated cocoalkyl-2-hydroxyethylamine containing from about 8 mols to about 30 mols of ethoxylate; or a mixture of a quaternary ethoxylated cocoalkyl-2-hydroxyethylamine, chloride containing from about 8 mols to about 30 mols of ethoxylate and of a tertiary ethoxylated cocoalkyl-2-hydroxyethylamine containing from about 8 mols to about 30 mols of ethoxylate. The surfactant can be non-biocidal.

The composition can be formulated as a ready-to-use composition or can be formulated as a liquid concentrate that is diluted prior to use. The surfactant can be present in a ready-to-use composition in an amount of greater than about 1 ppm, such as greater than about 10 ppm, such as greater than about 50 ppm, such as greater than about 100 ppm, such as greater than about 200 ppm, and generally in an amount less than about 1,000,000 ppm, such as in an amount less than about 50,000 ppm, such as in an amount less than about 25,000 ppm. The surfactant can be present in the composition in relation to one or more antimicrobial agents at a weight ratio of from about 1:10 to about 5,000:1, such as from about 10:1 to about 3,000:1.

The composition of the present disclosure can contain any suitable antimicrobial agent that is compatible with the surfactant. In one aspect, the antimicrobial agent can comprise one or more quaternary ammonium compounds. The quaternary ammonium compounds can have the following structure:

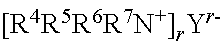

wherein
R⁴ is an optionally substituted benzyl group or an optionally substituted alkyl or aryl-substituted alkyl group;
R⁵ and R⁶ are independently optionally substituted alkyl groups;
R⁷ is selected from the group consisting of an optionally substituted alkyl or aryl-substituted alkyl group, benzyl group, and —[(CH₂)₂—O]n-R⁸, wherein n is an integer from 1 to 20 and R⁸ is selected from the group consisting of hydrogen, phenyl, and alkyl-substituted phenyl groups;
Y— is a chlorine ion, bromine ion, phosphate, carbonate, bicarbonate, acetate, ethosulfate, sulfate, propionate, or nitrate; and
r is 1, 2 or 3.

Examples of quaternary ammonium compounds that can be incorporated into the composition include an alkyl dimethyl benzyl ammonium chloride, at least one dimethyl dialkyl ammonium chloride, or an alkyl trimethyl ammonium compound. Particular examples of quaternary ammonium compounds that can be present in the composition include didecyl dimethyl ammonium chloride, an N,N-dialkyl-N,N-dimethylammonium carbonate and/or N,N-dialkyl-N,N-dimethylammonium bicarbonate, N,N-didecyl-N-methyl-poly(oxyethyl) ammonium propionate, octyl decyl dimethyl ammonium chloride, dioctyl dimethyl ammonium chloride, didecyl dimethyl ammonium chloride, tetradecane dimethyl benzyl ammonium chloride, dodecane dimethyl benzyl ammonium chloride, hexadecane dimethyl benzyl ammonium chloride, and a trimethylhexadecyl ammonium ion.

The one or more antimicrobial agents can be present in the composition in an amount less than about 1,000 ppm, such as in an amount less than about 500 ppm, such as in an amount less than about 250 ppm, such as in an amount less than about 100 ppm, such as in an amount less than about 50 ppm, such as even in an amount less than about 20 ppm. When the antimicrobial agent comprises one or more quaternary ammonium compounds, the antimicrobial agent can be present in an amount from about 1 ppm to about 500 ppm, while the surfactant can be present in an amount from about 10 ppm to about 5,000 ppm.

In addition to quaternary ammonium compounds, various other antimicrobial agents can be present in the composition. For instance, in one embodiment, the composition contains chlorhexidine. The chlorhexidine can be present alone or in combination with one or more quaternary ammonium compounds. When present, the chlorhexidine can be included in the ready-to-use composition in an amount from about 1 ppm to about 500 ppm.

The composition can also contain an amine, such as a tertiary amine. The amine can comprise bis(3-aminopropyl) dodecylamine. The amine can be present alone or in combination with chlorhexidine and/or one or more quaternary ammonium compounds. When present, the chlorhexidine can be included in the ready-to-use composition in an amount from about 1 ppm to about 2000 ppm.

As described above, the surfactant of the present disclosure can be included in the composition without adversely interfering with the efficacy of the antimicrobial agent. For instance, the composition can be formulated to exhibit a log reduction against a microorganism and wherein the log reduction is no less in comparison to an identical composition containing the one or more antimicrobial agents but not containing the surfactant. The microorganisms, for instance, can be Pseudomonas aeruginosa or Candida albicans.

In another aspect, the present disclosure is directed to a fabric treatment, such as a laundry detergent, containing one or more surfactants as described above. The one or more surfactants can be incorporated into the laundry detergent with or without an antimicrobial agent.

For example, in one aspect, the present disclosure is directed to a fabric treatment comprising a laundry detergent composition. The laundry detergent composition comprises a laundry detergent surfactant combined with one or more cationic surfactants. The one or more surfactants comprise:
an ethoxylated tertiary amine of the general formula (I):

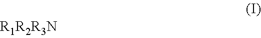

an ethoxylated quaternary amine of the general formula (II):

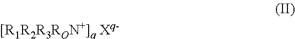

or mixtures thereof,
wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group, or a CH₂OH group and p is 0 or 1,
X is a counterion selected from the group consisting of species generated from a mineral acid or organic acid, and
q is 1, 2, 3 or 4.

The one or more surfactants as described above can be combined with various different laundry detergent surfactants. The laundry detergent surfactant, for instance, can comprise an alcohol alkoxylate, an alcohol ethoxy sulfate, an amine oxide, a monoethanolamine alkylbenzenesulfonate, a monoethanolamine alkyl benzene sulfonic acid, a monoethanolamine laureth sulfate, a sodium alkylbenzene sulfonate, a sodium lauryl sulfate, or mixtures thereof. The fabric treatment can also contain an enzyme, a fatty acid component, a perfume, a chelant, a radical scavenger, a soil release polymer, a soil suspension polymer, a whiting agent, a rheology modifier, or mixtures thereof.

In another aspect, the present disclosure is directed to a product comprising a liquid absorbent substrate and a composition contained or absorbed into the substrate that comprises a surfactant and an antimicrobial agent as described above. The liquid absorbent substrate can comprise a woven fabric, a knitted fabric, or a nonwoven web. The nonwoven web can comprise a meltblown web, a coform web, a spunbond web, an airlaid web, an airlaced web, a hydroentangled web, a bonded carded web, or any laminate thereof.

In still another aspect, the present disclosure is directed to a method for destroying microorganisms on an adjacent surface. The method includes saturating a liquid absorbent substrate with a composition containing a surfactant and at least one antimicrobial agent as described above. The saturated liquid absorbent substrate is then applied to a surface. The microorganism destroyed during the method can be a virus, a bacteria, a fungi, a yeast, an algae, a slime, or any combination thereof.

In still another aspect, the present disclosure is directed to use of a composition as described above wherein the composition is applied to an adjacent surface for destroying microorganisms or cleaning the surface. In still another aspect, the present disclosure is directed to use of a composition as described above wherein the composition is applied to a hard or soft surface for destroying microorganisms or cleaning the surface.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a graphical representation of some of the results obtained in the examples below;

FIG. 2 is a graphical representation of some of the results obtained in the examples below;

FIG. 3 is a graphical representation of some of the results obtained in the examples below;

FIG. 4 is a graphical representation of some of the results obtained in the examples below; and

FIG. 5 is a graphical representation of some of the results obtained in the examples below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

The present disclosure is generally directed to a composition containing one or more surfactants. In one aspect, the one or more surfactants can be incorporated into a disinfectant composition that contains at least one antimicrobial agent. The composition can be formulated as a ready-to-use solution or as a liquid concentrate. The composition has numerous uses and applications. For example, the composition can be used to disinfect all surfaces, including hard and soft surfaces. The composition, for instance, may comprise a hard surface disinfectant, a hand sanitizer, a sterilizing or high-level disinfectant composition, a pre-disinfectant cleaner for instruments, a soft surface disinfectant composition, an upholstery or fabric cleaner/disinfectant, or the like. The composition, for instance, can be used in the food and beverage field for cleaning food contact surfaces, such as counters, food service tables, food containers, and the like. In addition, the composition is also particularly well suited for use in the health field, such as in hospitals, emergency care centers, doctor and dentist offices, and the like.

In another aspect, the present disclosure is directed to methods for destroying microorganisms on a surface. For example, the composition can contain at least one antimicrobial agent in combination with one or more surfactants wherein the antimicrobial agent is at a concentration sufficient to destroy and kill many different types of microorganisms including viruses. Of particular advantage, the one or more surfactants can offer various advantages and benefits to the composition without significantly impacting the efficacy of the one or more antimicrobial agents. Thus, the concentration of the one or more antimicrobial agents can be minimized while still providing a composition sufficient to destroy all different types of microorganisms, including bacteria, fungi, yeast, algae, viruses, and the like.

The one or more surfactants contained within the composition can lower the surface tension. In addition, the surfactants can significantly improve the wetting and/or cleaning properties of the composition when applied to an adjacent surface. In this manner, the one or more surfactants enhance the action of the one or more antimicrobial agents by providing a more uniform and more effective contact against a surface. In addition, the one or more surfactants can also disperse the one or more antimicrobial agents within the composition, such as by dispersing the one or more antimicrobial agents better in a water-based solution.

The present disclosure is also directed to balancing the ratio between one or more surfactants and one or more antimicrobial agents. Compositions of the present disclosure can result in increased antimicrobial efficacy at minimum concentrations while providing a composition that can have enhanced wetting and cleaning properties. Compositions of the present disclosure can be incorporated into products that offer both cleaning and disinfect characteristics thus resulting in a single product with multiple benefits. The composition of the present disclosure can contain all different types of antimicrobial agents. For example, the composition is particularly well suited to containing one or more quaternary ammonium compounds either alone or in combination with other antimicrobial agents. The composition of the present disclosure is also well suited for use with guanidine antimicrobial agents. In one particular embodiment, a quaternary ammonium compound can be combined with a guanidine antimicrobial agent.

In an alternative embodiment, the one or more surfactants of the present disclosure can be incorporated into a fabric treatment. The fabric treatment, for instance, can be a laundry detergent composition, a fabric rinse, or the like. The one or more surfactants of the present disclosure can be incorporated into the fabric treatment for enhancing the removal of dirt, stains, and the like from fabrics. Because the one or more surfactants are compatible with various antimicrobial agents, the fabric treatment can optionally also contain one or more antimicrobial agents. In this manner, the fabric treatment can be used to clean and/or disinfect fabrics, clothing, and other textile materials. The fabric treatment, for instance, can include the one or more surfactants in accordance with the present disclosure combined with at least one laundry detergent surfactant. The fabric treatment can also contain an enzyme, a perfume, a chelant, a radical scavenger, a soil release polymer, a soil suspension polymer, a whiting agent, a rheology modifier, or mixtures thereof.

The one or more surfactants of the present disclosure can comprise a cationic or nonionic surfactant and/or a heavily alkoxylated surfactant that has been found to unexpectedly improve the ability of the composition to wet or clean adjacent surfaces without significantly affecting the efficacy of the one or more antimicrobial agents. In the past, for instance, surfactants were incorporated into disinfectant compositions that had a tendency to adversely affect the efficacy of the antimicrobial agent. Thus, in the past, those skilled in the art had to balance the relative amount between the surfactant and the antimicrobial agent in order to compensate for the unintended interference. The surfactants incorporated into the composition of the present disclosure, however, can overcome the above problem in a dramatic and unexpected way while enhancing the cleaning properties of the composition. In fact, the one or more surfactants of the present disclosure may be used in certain applications for their ability to clean surfaces or fabrics without being used in conjunction with an antimicrobial agent.

In one aspect, the surfactant of the present disclosure can comprise one or more ethoxylated tertiary amines, one or more ethoxylated quaternary amines, or a mixture containing one or more ethoxylated tertiary amines combined with one or more ethoxylated quaternary amines. The amine that forms the backbone of the surfactant can comprise a fatty amine, such as a fatty amine containing about 6 to about 28 carbon atoms.

For instance, the ethoxylated tertiary amine can comprise an ethoxylated fatty amine. As used herein, an “ethoxylated fatty amine” refers to a fatty amine compound that has two ethoxylated arms. The ethoxylated tertiary amine, for instance, may have the following general formula (I):

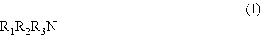

wherein,
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
Rₐ, R_{b}, R_{c}, R_{d}, Rₑ, R_{f} are independent of each other and comprise H, a methyl group, or a CH₂OH group.

The fatty acid portion of the surfactant, in one aspect, can be obtained from animal-based oils and fats derived from beef tallow, fish oil, lanolin, and the like. The fatty acid can also be obtained from plant-based oils and fats, such as those derived from coconut oil, palm oil, soybean oil, and the like. Examples of ethoxylated tertiary amines include ethoxylated tallow amine, ethoxylated lauryl amine, ethoxylated cocoalkyl amine, ethoxylated stearyl amine, ethoxylated oleyl amine, and mixtures thereof. In one aspect, for instance, the ethoxylated tertiary amine can comprise an ethoxylated stearyl amine, an ethoxylated cocoalkyl amine, or mixtures thereof.

The number of ethoxylate groups present in the ethoxylated tertiary amine can generally be greater than about 4, such as greater than about 5, such as greater than about 6, such as greater than about 7, such as greater than about 8, and less than about 40, such as less than about 30, such as less than about 26, such as less than about 22, such as less than about 18, such as less than about 14, such as less than about 12.

The two ethoxylate chains contained within the ethoxylated tertiary amine can be symmetrical with respect to the fatty amine or can be different. In one aspect, Rₐ, R_{b}, R_{c}, and R_{d} can all be hydrogen.

In another aspect, the at least one surfactant can comprise an ethoxylated quaternary amine. The ethoxylated quaternary amine, for instance, can comprise a quaternary fatty amine ethoxylate.

As used herein, a “quaternary fatty amine ethoxylate” refers to a quaternary ammonium compound that has two ethoxylated arms and further comprises a saturated or unsaturated, aliphatic or aromatic, substituted or unsubstituted C6 to C24 hydrocarbon or a mixture thereof.

In one particular embodiment, the surfactant can include two alkoxylate chains and can have the following structure:

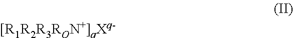

wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group, or a CH₂OH group and p is 0 or 1,
X is a counterion selected from the group consisting of species generated from a mineral acid or organic acid, and
q is 1, 2, 3 or 4.

In one aspect, the ethoxylated quaternary amine can be formed by quaternizing the ethoxylated tertiary amine to form the ethoxylated quaternary amine or a mixture of an ethoxylated quaternary amine and the ethoxylated tertiary amine. Thus, R₁, R₂, R₃, n, m, Rₐ, R_{b}, R_{c}, and R_{d} can have the same values or groups for the ethoxylated tertiary amine and for the ethoxylated quaternary amine.

As shown above, n together with m represents the total mols of ethoxylate groups present in R₂ and R₃ groups. In general, n and m can independently be greater than about 4, such as greater than about 5, such as greater than about 6, such as greater than about 7, such as greater than about 8. N and m are generally less than about 40, such as less than about 30, such as less than about 26, such as less than about 22, such as less than about 18, such as less than about 14, such as less than about 12. In one aspect, R₂ and R₃ groups can contain a total amount of ethoxylate groups (average) of greater than about 8 mols of ethoxylate groups, such as greater than about 10 mols of ethoxylate groups, such as greater than about 12 mols of ethoxylate groups, and less than about 30 mols of ethoxylate groups, such as less than about 26 mols of ethoxylate groups, such as less than about 24 mols of ethoxylate groups.

As shown above, the ethoxylated quaternary amine can also include a counterion that can be generated from a mineral acid or an organic acid. Examples of acids include hydrochloric acid, hydrobromic acid, nitric acid, phosphoric acid, sulfuric acid, boric acid, hydrofluoric acid, perchloric acid, formic acid, acetic acid, 2-ethylhexanoic acid, lactic acid, and the like.

In one aspect, the two alkoxylate chains can be identical or can be different.

In one aspect, p is 0. In one aspect, Rₐ, R_{b}, R_{c}, R_{d}, Rₑ, and R_{f} are all hydrogen.

The surfactants described above contain a fatty amine. The fatty amine, in one aspect, can be obtained from animal-based oils and fats derived from beef tallow, fish oil, lanolin, and the like. The fatty amine can also be obtained from plant-based oils and fats, such as those derived from coconut oil, palm oil, soybean oil, and the like. The fatty amine can also be a synthetic molecule.

The fatty acid portion of the molecule can be saturated or unsaturated. The fatty acid, for instance, can have a carbon chain length of greater than about 4 carbon atoms, such as greater than about 6 carbon atoms, such as greater than about 8 carbon atoms, and generally less than about 28 carbon atoms, such as less than about 26 carbon atoms, such as less than about 24 carbon atoms, such as less than about 22 carbon atoms, such as less than about 20 carbon atoms. Suitable alkyl- or alkenyl-fatty groups contained in the fatty amine, for instance, may include hexyl, heptyl, n-octyl, p-tert. octyl, n-nonyl-, p-tert. nonyl, decyl, lauryl, tridecyl, myristyl, palmityl, stearyl, arachidyl, hydroabietyl or behenyl, 2-ethylhexyl, 2-propylheptyl, linolenyl, stearidonyl, linoleyl, arachidonyl, palmitoleyl, oleyl, elaidyl, tallow alkyl, hydrogenated tallow alkyl, rape seed alkyl, soya alkyl, coco alkyl and the like.

The surfactants of the present disclosure can be characterized by having two alkoxylate chains, such as two ethoxylate chains. Particular examples of the surfactant or mixture of surfactants well suited for use in the composition include a quaternary ethoxylated stearyl-2-hydroxyethylamine, chloride containing an average of from about 8 mols to about 30 mols of ethoxylate; a tertiary ethoxylated stearyl-2-hydroxyethylamine containing an average of from about 8 mol to about 30 mol of ethoxylate; a mixture of quaternary ethoxylated stearyl-2-hydroxyethylamine, chloride containing an average of from about 8 mols to about 30 mols of ethoxylate and of a tertiary ethoxylated stearyl-2-hydroxyethylamine containing an average of from about 8 mol to about 30 mol of ethoxylate; a quaternary ethoxylated cocoalkyl-2-hydroxyethylamine, chloride containing an average of from about 8 mols to about 30 mols of ethoxylate; a tertiary ethoxylated cocoalkyl-2-hydroxyethylamine containing an average of from about 8 mols to about 30 mols of ethoxylate; or a mixture of a quaternary ethoxylated cocoalkyl-2-hydroxyethylamine, chloride containing an average of from about 8 mols to about 30 mols of ethoxylate and of a tertiary ethoxylated cocoalkyl-2-hydroxyethylamine containing an average of from about 8 mols to about 30 mols of ethoxylate.

The chemical structure of the surfactants as shown above (both the ethoxylated tertiary amine and the ethoxylated quaternary amine surfactants) includes an alkyl group R₁. The surfactant of the present disclosure can include a single R₁ group having the same carbon chain length or can include a mixture of R₁ groups that have different carbon chain lengths. In general, R₁ can have a carbon chain length of greater than about 4 carbon atoms, such as greater than about 8 carbon atoms, such as greater than about 10 carbon atoms, such as greater than about 12 carbon atoms, such as greater than about 14 carbon atoms. The carbon chain length of R₁ is generally less than about 28 carbon atoms, such as less than about 26 carbon atoms, such as less than about 24 carbon atoms, such as less than about 22 carbon atoms, such as less than about 20 carbon atoms.

In one aspect, the surfactant incorporated into the composition whether an ethoxylated tertiary amine or an ethoxylated quaternary amine of the present disclosure has an R₁ distribution such that greater than about 70%, such as greater than about 75%, such as greater than about 80%, such as greater than about 85%, such as greater than 90%, such as greater than 95%, and up to about 100%, such as less than about 95% of the R₁ groups have a carbon chain length of 18 carbon atoms. In this embodiment, the surfactant can include an R₁ distribution such that less than about 18%, such as less than about 15%, such as less than about 12% of the R₁ groups have a carbon chain length of 16 carbon atoms or less. The R₁ distribution can also include R₁ groups having a chain length of greater than 18 carbon atoms in an amount less than about 5%, such as in amounts less than about 3%. The surfactant can contain generally from about 10 ethoxylate groups to about 40 ethoxylate groups, such as from about 12 ethoxylate groups to about 22 ethoxylate groups.

In another aspect, the R1 groups contained in the surfactant can have a broader and more varied carbon chain length distribution. For instance, the surfactant can contain R1 groups having a carbon chain length of 8 carbon atoms in an amount greater than about 1%, such as in an amount greater than about 2%, such as in an amount greater than about 3%, and in an amount less than about 8%, such as in an amount less than about 6%, such as in an amount less than about 5%. The surfactant can contain R1 groups having a carbon chain length of 10 carbon atoms in an amount greater than about 2%, such as in an amount greater than about 3%, such as in an amount greater than about 4%, and in an amount less than about 8%, such as in an amount less than about 7%, such as in an amount less than about 6%. The surfactant can contain R1 groups having a carbon chain length of 12 carbon atoms in an amount greater than about 40%, such as in an amount greater than about 45%, such as in an amount greater than about 50%, such as in an amount greater than about 52%, and in an amount less than about 65%, such as in an amount less than about 60%, such as in an amount less than about 58%. The surfactant can contain R1 groups having a carbon chain length of 14 carbon atoms in an amount greater than about 10%, such as in an amount greater than about 12%, such as in an amount greater than about 16%, and in an amount less than about 26%, such as in an amount less than about 24%, such as in an amount less than about 20%. The surfactant can contain R1 groups having a carbon chain length of 16 carbon atoms in an amount greater than about 4%, such as in an amount greater than about 6%, such as in an amount greater than about 8%, and in an amount less than about 18%, such as in an amount less than about 16%, such as in an amount less than about 14%, such as in an amount less than about 12%. The surfactant can contain R1 groups having a carbon chain length of 18 carbon atoms in an amount greater than about 4%, such as in an amount greater than about 6%, such as in an amount greater than about 8%, and in an amount less than about 18%, such as in an amount less than about 16%, such as in an amount less than about 14%, such as in an amount less than about 12%. Each hydrocarbon above can be saturated, unsaturated, or a mixture of saturated and unsaturated hydrocarbons. In one embodiment, the C18 hydrocarbon comprises 1% to 5% of a saturated hydrocarbon and 4% to 8% of an unsaturated hydrocarbon. Alternatively, the C18 hydrocarbon is comprised entirely of a saturated hydrocarbon.

The surfactant, such as the ethoxylated quaternary amine or the ethoxylated tertiary amine, can have a molecular weight (MW) of greater than about 600 g/mol, such as greater than about 700 g/mol, such as greater than about 750 g/mol, such as greater than about 800 g/mol. The molecular weight can be less than about 3,000 g/mol, such as less than about 2,000 g/mol, such as less than about 1,500 g/mol, such as less than about 1,400 g/mol, such as less than about 1,300 g/mol, such as less than about 1,200 g/mol.

The composition of the present disclosure can optionally contain one or more surfactants as described above combined with various different antimicrobial agents. The composition, for instance, can contain a single antimicrobial agent or a single type of antimicrobial agent or a mixture of different antimicrobial agents. Examples of antimicrobial agents that can be incorporated into the composition include quaternary ammonium compounds, guanidine compounds, mixtures thereof, and the like.

In one embodiment, the composition contains at least one quaternary ammonium compound. For example, in one aspect, the quaternary ammonium compound can have the following chemical structure:

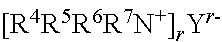

wherein R⁴ is an optionally substituted benzyl group or an optionally substituted alkyl or aryl-substituted alkyl group;
R⁵ and R⁶ are independently optionally substituted alkyl groups;
R⁷ is selected from the group consisting of an optionally substituted alkyl or aryl-substituted alkyl group, benzyl group, and —[(CH₂)₂—O]n-R⁸, wherein n is an integer from 1 to 20 and R⁸ is selected from the group consisting of hydrogen, phenyl, and alkyl-substituted phenyl groups;
Y— is a chlorine ion, bromine ion, phosphate, carbonate, bicarbonate, acetate, ethosulfate, sulfate, propionate, or nitrate; and
r is 1, 2 or 3.

In one embodiment, the quaternary ammonium compound may comprise a dialkyl ammonium compound, such as a dimethyl dialkyl ammonium compound. In one embodiment, the dimethyl dialkyl ammonium compound may have between about 8 and about 12 carbon atoms, such as from about 8 to about 10 carbon atoms in each of the alkyl groups.

Examples of dimethyl dialkyl ammonium compounds which may be used include dimethyl dioctyl ammonium compounds such as dimethyl dioctyl ammonium chloride, dimethyl didecyl ammonium compounds such as dimethyl didecyl ammonium chloride and the like. Mixtures of dimethyl dialkyl ammonium compounds may also be used and other anions, such as those described above may also be used. Commercially available dimethyl dialkyl ammonium compounds include, for example, compositions marketed and sold under the BARDAC™ tradename by Arxada AG.

In an alternative embodiment, the antimicrobial agent may comprise a benzyl ammonium compound, such as an alkyl dimethyl benzyl ammonium compound. In general, the alkyl group may contain from about 10 to about 18 carbon atoms, such as from about 12 to about 16 carbon atoms.

Examples of alkyl dimethyl benzyl ammonium compounds include C12 alkyl dimethyl benzyl ammonium chloride, C14 alkyl dimethyl benzyl ammonium chloride, and C16 alkyl dimethyl benzyl ammonium chloride. In addition, a mixture of these alkyl dimethyl benzyl ammonium compounds can be used. Commercially available alkyl dimethyl benzyl ammonium compounds include, for example, compositions marketed and sold under the BARQUAT® tradename by Arxada AG. These commercially available alkyl dimethyl benzyl ammonium compounds are blends of C12, C14, and C16 alkyl dimethyl benzyl ammonium chlorides. Generally, it is preferable that the alkyl dimethyl benzyl ammonium compound, when a blend, contains higher concentrations of C12 alkyl and C14 alkyl components than C16 alkyl components. It is noted that other anions, including those mentioned above, may also be used.

In still another embodiment, the quaternary ammonium compound may comprise a quaternary ammonium propionate. The quaternary ammonium propionate, for instance, may comprise a poly(oxyalkyl)ammonium propionate. In one particular embodiment, for instance, the first biocide may comprise N,N-didecyl-N-methyl-poly(oxyethyl)ammonium propionate.

In one aspect, the antimicrobial agent(s) comprises a carbonate/bicarbonate salt of a quaternary ammonium cation. For example, the antimicrobial agent contained in the composition can comprise a di C₈-C₁₂ alkyl ammonium carbonate/bicarbonate. In one particular embodiment, the composition contains didecyl dimethyl ammonium carbonate and/or didecyl dimethyl ammonium bicarbonate.

In other embodiments, however, the carbonate/bicarbonate salts of quaternary ammonium cations may be selected from dioctyldimethylammonium carbonate, decyloctyldimethylammonium carbonate, benzalkonium carbonate, benzethonium carbonate, stearalkonium carbonate, cetrimonium carbonate, behentrimonium carbonate, dioctyldimethylammonium bicarbonate, decyloctyldimethylammonium bicarbonate, benzalkonium bicarbonate, benzethonium bicarbonate, stearalkonium bicarbonate, cetrimonium bicarbonate, behentrimonium bicarbonate, and mixtures of one or more such carbonate salts.

In another aspect, the quaternary ammonium compound can comprise an alkyl trimethyl ammonium compound, such as an alkyl trimethyl ammonium chloride. The alkyl group, for instance, can have a carbon chain length of from about 8 carbon atoms to about 20 carbon atoms. In one particular embodiment, the quaternary ammonium compound can be a trimethyl hexadecyl ammonium ion, such as a trimethyl hexadecyl ammonium chloride.

In another aspect, the antimicrobial agent incorporated into the composition in conjunction with one or more surfactants can be a guanidine compound. For example, any suitable guanidine compound can be incorporated into the composition that displays biocidal activity. In one aspect, for instance, the guanidine compound can be a chlorhexidine. Chlorhexidine is commonly represented by the following formula:

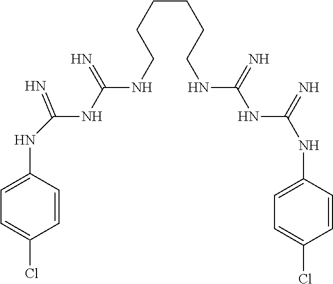 [SMILES: N=C(NCCCCCCNC(=N)NC(=N)Nc1ccc(Cl)cc1)NC(=N)Nc1ccc(Cl)cc1]

In one embodiment, the chlorhexidine may comprise a chlorhexidine salt. For example, the antimicrobial agent may comprise chlorhexidine gluconate, chlorhexidine hydrochloride, or chlorhexidine acetate.

In addition to quaternary ammonium cations and/or a quanidine, the antimicrobial agent may comprise an amine. The amine can be present alone or in combination with the other antimicrobial agents.

Suitable amines include, but are not limited to, tertiary amines, such as (C6-C16) alkyl amines. The term “(C6-C16) alkyl amine” encompasses all amines which contain a (C6-C16) alkyl group. One (C6-C16) alkyl amine is N,N-bis(3-aminopropyl)dodecylamine.

Other exemplary tertiary amines include, for example, N-(3-aminopropyl)-N-dodecyl propane-1,3-diamine, N-(3-aminopropyl)-N-decyl-1,3-propanediamine, N-(3-aminopropyl)-N-tetradecyl-1,3-propanediamine as well as their acid addition compounds.

As described above, the composition of the present disclosure may contain a single antimicrobial agent, a mixture of two or more antimicrobial agents from a single type of antimicrobial agent or may be a mixture of two or more different types of antimicrobial agents. For example, the composition may contain a single quaternary ammonium compound or a mixture of quaternary ammonium compounds. Alternatively, the composition can contain one or more quaternary ammonium compounds in combination with one or more guanidine compounds and/or amines. In still another aspect, the composition can contain one or more guanidine compounds without containing any other antimicrobial agents.

The amount of the one or more alkoxylated surfactants, the amount of the one or more antimicrobial agents, and the ratio between the different components can vary widely depending upon the particular application, the desired end use, the microorganisms to be controlled, and the like. In one aspect, one or more quaternary and/or tertiary alkoxylated fatty amine surfactants can be present in the composition in an amount greater than about 1 ppm, such as in an amount greater than about 10 ppm, such as in an amount greater than about 50 ppm, in an amount greater than about 100 ppm, such as in an amount greater than about 200 ppm, such as in an amount greater than about 300 ppm, such as in an amount greater than about 400 ppm, such as in an amount greater than about 500 ppm, such as in an amount greater than about 600 ppm, such as in an amount greater than about 700 ppm, such as in an amount greater than about 800 ppm, such as in an amount greater than about 900 ppm, such as in an amount greater than about 1,000 ppm, such as in an amount greater than about 1,100 ppm, such as in an amount greater than about 1,200 ppm, such as in an amount greater than about 1,300 ppm, such as in an amount greater than about 1,400 ppm, such as in an amount greater than about 1,500 ppm, such as in an amount greater than about 1,600 ppm, such as in an amount greater than about 1,700 ppm, such as in an amount greater than about 1,800 ppm, such as in an amount greater than about 1,900 ppm, such as in an amount greater than about 2,000 ppm. One or more surfactants are generally present in the composition in an amount less than about 5,000,000 ppm, such as in an amount less than about 1,000,000 ppm, such as in an amount less than about 500,000 ppm, such as in an amount less than about 100,000 ppm, such as in an amount less than about 50,000 ppm, such as in an amount less than about 25,000 ppm, such as in an amount less than about 10,000 ppm, such as in an amount less than about 9,000 ppm, such as in an amount less than about 8,000 ppm, such as in an amount less than about 7,000 ppm, such as in an amount less than about 6,000 ppm, such as in an amount less than about 5,000 ppm, such as in an amount less than about 4,000 ppm, such as in an amount less than about 3,000 ppm, such as in an amount less than about 2,000 ppm, such as in an amount less than about 1,000 ppm, such as in an amount less than about 900 ppm, such as in an amount less than about 800 ppm, such as in an amount less than about 700 ppm, such as in an amount less than about 600 ppm, such as in an amount less than about 500 ppm, such as in an amount less than about 400 ppm, such as in an amount less than about 300 ppm. The above concentrations generally are for a ready-to-use composition but may also cover liquid disinfectant concentrates. Liquid concentrates, however, can contain one or more surfactants in an amount from about 1,000 ppm to about 5,000,000 ppm, including all increments of 100 ppm therebetween.

As explained above, the amount of one or more antimicrobial agents contained in the composition can vary widely depending upon the antimicrobial agent present and various other factors. In one aspect, the antimicrobial agent can be present in a ready-to-use composition such as in an amount less than about 1,000 ppm, such as in an amount less than about 750 ppm, such as in an amount less than about 500 ppm, such as less than about 450 ppm, such as less than about 400 ppm, such as less than about 350 ppm, such as less than about 300 ppm, such as less than about 250 ppm, such as less than about 200 ppm, such as less than about 150 ppm, such as less than about 100 ppm, such as less than about 90 ppm, such as less than about 80 ppm, such as less than about 70 ppm, such as less than about 60 ppm, such as less than about 50 ppm, such as less than about 40 ppm, such as less than about 30 ppm, such as less than about 20 ppm, such as less than about 10 ppm. The one or more antimicrobial agents are generally present in the composition in an amount greater than about 0.01 ppm, such as in an amount greater than about 0.1 ppm, such as in an amount greater than about 1 ppm, such as in an amount greater than about 2 ppm, such as in an amount greater than about 4 ppm, such as in an amount greater than about 5 ppm, such as in an amount greater than about 10 ppm, such as in an amount greater than about 15 ppm, such as in an amount greater than about 20 ppm, such as in an amount greater than about 25 ppm, such as in an amount greater than about 30 ppm, such as in an amount greater than about 40 ppm, such as in an amount greater than about 50 ppm, such as in an amount greater than about 60 ppm, such as in an amount greater than about 70 ppm, such as in an amount greater than about 80 ppm, such as in an amount greater than about 90 ppm, such as in an amount greater than about 100 ppm, such as in an amount greater than about 150 ppm, such as in an amount greater than about 200 ppm, such as in an amount greater than about 250 ppm, such as in an amount greater than about 300 ppm.

The weight ratio between the one or more surfactants and the one or more antimicrobial agents can generally be from about 1:10 to about 50,000:1. In one aspect, the surfactant is present at a greater concentration or in a greater amount than the one or more antimicrobial agents. In various embodiments, the weight ratio between the surfactant and the one or more antimicrobial agents can be from about 1:1 to about 5,000:1, such as from about 10:1 to about 5,000:1, such as from about 10:1 to about 3,000:1. In particular embodiments, the weight ratio between the surfactant and the one or more antimicrobial agents can be from about 10:1 to about 500:1, such as from about 20:1 to about 400:1, such as from about 100:1 to about 300:1. The above weight ratios, however, are for exemplary purposes only and are not intended to limit the broader aspects of the invention.

Particular and dramatic synergistic effect has been observed when the one or more surfactants of the present disclosure are combined with one or more quaternary ammonium compounds in a composition. Thus, when the composition contains one or more quaternary ammonium compounds, the ready-to-use composition can contain one or more quaternary ammonium compounds at concentrations well below about 500 ppm, such as below about 250 ppm, such as well below about 100 ppm, such as less than about 50 ppm, such as less than about 40 ppm, such as less than about 30 ppm, such as less than about 20 ppm, such as less than about 10 ppm. For example, very effective compositions can be formulated in accordance with the present disclosure in which the composition contains one or more quaternary ammonium compounds at a concentration of from about 0.5 ppm to about 20 ppm, such as from about 1.5 ppm to about 8 ppm. The one or more surfactants can be present in the composition in relation to the at least one quaternary ammonium compound at a weight ratio of from about 1:10 to about 4,000:1, such as from about 20:1 to about 2,000:1, such as from about 150:1 to about 1,000:1.

In one aspect, the composition can contain at least one dimethyl dialkyl ammonium chloride, such as didecyl dimethyl ammonium chloride. In one aspect, the composition can contain octyl decyl dimethyl ammonium chloride, dioctyl dimethyl ammonium chloride, and didecyl dimethyl ammonium chloride.

In an alternative embodiment, the composition can contain one or more surfactants in combination with an alkyl dimethyl benzyl ammonium chloride. For instance, the composition can contain tetradecane dimethyl benzyl ammonium chloride, dodecane dimethyl benzyl ammonium chloride, and hexadecane dimethyl benzyl ammonium chloride.

In still another aspect, the one or more surfactants can be combined with a quaternary ammonium carbonate and/or bicarbonate in order to form the composition. For example, the quaternary ammonium compound can be a blend of didecyl dimethyl ammonium carbonate and didecyl dimethyl ammonium bicarbonate. In addition to being an effective antimicrobial agent, quaternary ammonium carbonates and bicarbonates are also corrosion inhibitors.

In another aspect, the composition contains a guanidine in combination with the one or more surfactants. The guanidine, for instance, can be a chlorohexidine. In one aspect, the surfactant can be present in relation to the chlorohexidine at a weight ratio of from about 1:10 to about 8,000:1, such as from about 5:1 to about 2,000:1.

As described above, the composition of the present disclosure can be formulated, in one aspect, as a liquid concentrate that can be diluted with a solvent prior to use. In the liquid concentrate, the amount of the antimicrobial agent will be higher than typical final use amounts.

Dilution of the concentrate will typically be with an aqueous solvent prior to use. One particular aqueous solvent which can be used is water. Dilution can be any amount of the solvent needed to get the concentrate diluted to a desired level of active ingredient for its intended use. Is typically such that the set amount of the concentrated is added to a specified amount of the solvent. For example, one ounce of the concentrate can be added to a pint of solvent for a 1:16 dilution rate; one ounce of concentrate can be added to a quart of a solvent for a 1:32 dilution rate, one ounce of concentrate can be added to % gallon of solvent for a 1:64 dilution rate; one ounce of concentrate can be added to one gallon of water for a 1:128 dilution rate and so one. Likewise metric dilution rates could also be used, for example 10 ml per liter for a 1:100 dilution rate, and the like.

The antimicrobial agent and the one or more surfactants may be combined with various different components. For instance, in one embodiment, a solvent can be present in the product. Generally, the solvent will be a polar solvent such as water, or a water-miscible solvent, such as an alcohol and/or a glycol ether. In addition to water, the composition can further include a water-miscible organic solvent. Examples of water-miscible solvents include ethanol, propanol, benzyl alcohol, phenoxyethanol, isopropanol, diethylene glycol propyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol mono-n-butyl ether, ethylene glycol dimethyl ether, ethylene glycol diethyl ether, ethylene glycol dibutyl ether, propylene glycol n-butyl ether, tripropylene glycol methyl ether, dipropylene glycol methyl ether, dipropylene glycol butyl ether and combinations thereof.

Additionally, the composition may contain an optional sequestering agent. Sequestering agents include, for example, acetic acid derivative selected from the group consisting of ethylenediaminetetraacetic acid (EDTA), nitrilotriacetic acid (NTA), tetrasodium EDTA. The sequestering agent may also serve to bind other metal ions that may adversely affect the effectiveness of the disinfecting components in the composition. In addition, sequestering agent may also assist in soil removal and/or preventing soil redeposition into the disinfecting composition while in use. The sequestering agents, when present in the concentrate is generally present in an amount up to about 20% by weight, and are typically present in an amount of about 2 to about 8% by weight.

The composition may also contain a pH adjusting agent. Suitable pH adjusting agents include sodium hydroxide, sodium citrate and other similar compounds. In the present invention, the concentrate and the final composition will have a pH in the range of about 6 to about 13. Generally, the composition will be considered a neutral disinfecting composition if the pH is in the range of about 6 to about 8. The composition will be considered an alkaline composition when the pH is in the range of above 8 to about 12.

The composition may optionally further contain corrosion inhibitors, complexing agents, auxiliaries, preservatives, fragrances, colorants and the like. Exemplary corrosion inhibitors include, for example, organic phosphorous compounds and blend of organic phosphorous compounds with a polymeric component. Exemplary auxiliaries include, for example, polyethylene glycol or other similar compounds. Colorants and fragrances may be added provided they do not interfere with the function of the composition and may serve for identifying the composition. Generally, the optional further ingredients will make up less than about 20% by weight of the composition.

The composition may also comprise at least one acid or salt thereof. The acid may be an inorganic acid or an organic acid. In a preferred embodiment the acid is a C1 to C8 carboxylic acid. In a particular embodiment, the acid is a monocarboxylic acid, a dicarboxylic acid, a tricarboxylic acid, or a mixture thereof. In an additional embodiment, the acid is a hydroxyl acid, an aromatic acid, or a mixture thereof. In another additional embodiment, the acid is boric acid, methanesulfonic acid, phosphoric acid, etidronic acid, phytic acid, phosphoacetic acid, N-(phosphonomethyl)iminodiacetic acid, diethylenetriaminepentakis(methylphosphonoic acid), S,S-ethylenediamine-N′N′-disuccinic acid, their alkaline salts, or any mixture thereof.

In some embodiments, the acid is citric acid, phosphoric acid, succinic acid, lactic acid, S,S-ethylenediamine-N,N′-disuccinic acid, 1-hydroxyethane 1,1-diphosphonic acid (HEDP), dipicolinic acid (DPA), methanesulfonic acid (MSA), their alkaline salts, or any mixture thereof.

In one embodiment, the acid is a mixture of acids. In some embodiments, the acid comprises one or more of the following organic acids: citric acid, succinic acid, phosphoric acid, and lactic acid. In another embodiment, the acid comprises one or more of the following acids: citric acid, succinic acid, phosphoric acid, and lactic acid, in combination with another acid. For example, citric acid may be used in combination with ethylenediamine-N,N′-disuccinic acid or its alkaline salt, HEDP, and/or MSA. As another example, succinic acid may be used in combination with ethylenediamine-N,N′-disuccinic acid or its alkaline salt, HEDP, and/or MSA. As another example, phosphoric acid may be used in combination with ethylenediamine-N,N′-disuccinic acid or its alkaline salt, HEDP, and/or MSA. As another example, lactic acid may be used in combination with ethylenediamine-N,N′-disuccinic acid or its alkaline salt, HEDP, and/or MSA.

The composition may include from about 1% by weight to about 5% by weight of an organic acid such as citric acid, succinic acid, phosphoric acid, lactic acid, or any mixture thereof, in combination with another acid. In another aspect, the composition may include from about 1% by weight to about 5% by weight of an organic acid such as citric acid, succinic acid, phosphoric acid, lactic acid, or any mixture thereof, in combination with from about 0.05% by weight to about 5% by weight of another acid. In another embodiment, the composition may include from about 2% by weight to about 4% by weight of an organic acid such as citric acid, succinic acid, phosphoric acid, lactic acid, or any mixture thereof, in combination with from about 0.1% by weight to about 4% by weight of another acid such as ethylenediamine-N,N′-disuccinic acid or its alkaline salt, HEDP, and/or MSA.

Various different compositions can be made in accordance with the present disclosure. The composition may be used, for instance, to clean hard surfaces, to pre-clean sterilize or high-level disinfect instruments, and/or as a hand sanitizer.

In one aspect, the composition of the present disclosure can also be incorporated into laundry detergents, fabric rinses, and other fabric treatments.

Indeed, elimination of certain gram negative bacteria from laundered clothing utilizing antimicrobial agents, such as quaternary ammonium compounds, can pose many challenges. For starters, most laundry sanitizers are required by various government regulations to eliminate at least 99.9% of bacteria on cotton during either the pre-wash, main wash, or rinse stage of the laundry cycle. Accordingly, laundry sanitizers must be formulated with enough antimicrobial agent to eliminate high percentages of harmful bacteria. However, laundry sanitizers can become highly diluted at the point of use (i.e. 100-200 times) and certain biocide compounds, such as quaternary ammonium compounds, used as active ingredients can readily absorb into fabric materials, such as cotton, thereby reducing their efficacy against the bacteria. The surfactant of the present disclosure, however, has been found to improve the efficacy of antimicrobial agents incorporated into fabric treatments.

The fabric treatments of the present disclosure are effective for killing pathogens, such as gram negative bacteria, on fabrics/clothes in the pre-wash, wash, or rinse water cycle during the laundry cycle of a washing machine.

The one or more surfactants of the present disclosure are not only well suited for use with antimicrobial agents but can also provide cleaning benefits, such as improved fabric cleaning. Consequently, in one embodiment, a fabric treatment can be constructed in accordance with the present disclosure containing an ethoxylated tertiary amine, an ethoxylated quaternary amine, or mixtures thereof, without also containing an antimicrobial agent.

The fabric treatment or laundry detergent can contain one or more a laundry or detergent surfactants in addition to the one or more surfactants of the present disclosure. For instance, when the fabric treatment comprises a laundry detergent, additional surfactants may be present to provide detergent characteristics. For example, in some embodiments, the fabric treatment comprises, by weight of the composition, from about 0%-25% of additional surfactants. These additional surfactants may comprise one or more nonionic, cationic and/or zwitterionic (also called amphoteric) surfactants, and mixtures thereof.

Suitable nonionic surfactants useful herein can comprise any nonionic surfactant well suited for use in liquid and/or solid detergent products. Preferred for use in the liquid fabric treatment are those nonionic surfactants which are normally liquid.

In one aspect, the laundry surfactant component may comprise one or more nonionic surfactants, such as an ethoxylated nonionic surfactant.

Suitable nonionic surfactants for use herein include alcohol alkoxylate nonionic surfactants. Alcohol alkoxylates are materials which correspond to the general formula: R9(CmH2mO)nOH wherein R9 is a C8-C16 alkyl group, m is from 2 to 4, and n ranges from about 2 to 12. Preferably R9 is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, alternatively from about 3 to 10 ethylene oxide moieties per molecule.

The alkoxylated fatty alcohol materials useful in the fabric treatments herein will frequently have a hydrophilic-lipophilic balance (HLB) which ranges from about 3 to 17. In one embodiment, the HLB of this material will range from about 6 to 15, alternatively from about 8 to 15. Alkoxylated fatty alcohol nonionic surfactants have been marketed under the tradenames Neodol and Dobanol by the Shell Chemical Company.

Non-limiting examples of nonionic surfactants useful herein include: a) C12-C18 alkyl ethoxylates; b) C6-C12 alkyl phenol alkoxylates wherein the alkoxylate units are a mixture of ethyleneoxy and propyleneoxy units; c) C12-C18 alcohol and C6-C12 alkyl phenol condensates with ethylene oxide/propylene oxide block polymers; d) C14-C22 mid-chain branched alcohols, BA, as discussed in U.S. Pat. No. 6,150,322 which is incorporated by reference herein; e) C14-C22 mid-chain branched alkyl alkoxylates, BAEx, wherein x 1-30; f) Alkylpolysaccharides, such as alkylpolyglycosides; g) polyhydroxy fatty amides; and h) ether capped poly(oxyalkylated) alcohol surfactants.

In one aspect, however, the fabric treatments of the present disclosure are substantially free of certain nonionic surfactants, such as certain ethoxylated nonionic surfactants including linear alcohol ethoxylates and liner alkyl sulphonates. Certain nonionic surfactants, such as linear alcohol ethoxylates and linear alkyl sulphonates (e.g. linear alkyl benzene sulphonates), may interfere with the antimicrobial properties of the antimicrobial agents provided herein. Accordingly, in certain embodiments where the antimicrobial agent comprises a quaternary ammonium compound, the fabric treatment may be absent of nonionic surfactants or of certain nonionic surfactants that may disable or interfere with the antimicrobial properties of certain quaternary ammonium compounds. In some embodiments, the fabric treatment may be substantially free of linear alcohol ethoxylates and linear alkyl benzene sulphonates.

In one aspect, the fabric treatment may contain an amphoteric surfactant. Several non-limiting examples of amphoteric surfactants useful herein include beta-n-alkylaminopropionic acids, n-alkyl-beta-iminodipropionic acids, imidazoline carboxylates, amine oxides, sultaines, betaines, phosphocholines, propionates, di-propionates, sodium cocoamphoacetate, disodium cocoamphodiacetate, 3-[(3-Cholamidopropyl)dimethylammonio]-1-propanesulfonate (CHAPS), dipalmitoylphosphatidylcholine (DPPtdCho), sodium lauroamphocetate and any combinations of any of the foregoing.

Several non-limiting examples of amine oxides include octyl dimethyl amine oxide (i.e. Barlox 8S), decyl dimethyl amine oxide (i.e. Barlox 10S), lauryldimethylamine oxide (i.e. Barlox @12), cocoalkyldimethyl amine oxide, myristyldimethyl amine oxide (i.e. Barlox @14), octyldimethyl amine oxide, decyldimethyl amine oxide, lauryldimethyl amine oxide, isoalkyl dimethyl amine oxide tetradecyldimethylaminoxide and cetyldimethyl amine oxide. Several non-limiting examples of betaines include lauramidopropyl betaine, cocamidopropyl betaine (i.e. and Dehyton® PK45), lauramidopropyl betaine, cetyl betaine, oleamidopropyl betaine and ricinoleamidopropyl betain. Several non-limiting examples of sultaines include cocamidopropyl hydroxysultaine, lauramidopropyl hydroxysultaine, cocamidopropyl hydroxysultaine, oleamidopropyl hydroxysultaine, tallowamidopropyl hydroxysultaine, erucamidopropyl hydroxysultaine and lauryl hydroxysultaine. Several non-limiting examples of phosphocholines include dodecylphosphocholine. Several non-limiting examples of propionates include ß-Alanine, N-(2-carboxyethyl)-, N-coco alkyl derivatives. Several non-limiting examples of di-propionates include disodium capryloamphodipropionate and disodium cocoamphodipropionate.

Particular laundry or detergent surfactants that may be incorporated into the fabric treatment include a C12 to C15 alcohol ethoxylate, an alcohol ethoxysulfate, a C10 to C16 alkyl dimethyl amine oxide, a C12 to C16 pareth, a C14 to C15 pareth, a C10 to C16 pareth, a polyethylene glycol ether, a salt of a fatty acid, a monoethanol amine alkylbenzene sulfonate, such as monoethanolamine dodecylbenzene sulfonate, a monoethanolamine alkyl benzene sulfonic acid, such as a C10 to C16 alkylbenzene sulfonic acid, a monoethanolamine laureth sulfate, a sodium alkylbenzene sulfonate, such as a sodium C10 to C16 alkylbenzene sulfonate, a sodium lauryl sulfate, or mixtures thereof.

The fabric treatments of the present disclosure may have a viscosity in the range of from water thin (e.g. 1 mPa s) to about 12,000 mPa·s (milli Pascal seconds), or alternatively in the range of from about 150 to about 5,000 mPa·s. The fabric treatments herein may be in the form of a gel, pourable gels, non-pourable gels, liquid, or heavy-duty liquids.

“Gel” as used herein includes a shear thinning gel with a pouring viscosity in the range of from 1,000 to 5,000 mPa·s, in one embodiment less than 3,000 mPa·s, alternatively less than 1,500 mPa·s. Gels may include thick liquids. More generally, a thick liquid may be a Newtonian fluid, which does not change its viscosity with the change in flow condition, such as honey or syrup. This type of thick liquid is very difficult and messy to dispense. A different type of liquid gel is shear-thinning, i.e. it is thick under low shear (e.g., at rest) and thin at high flow rates.

Other compositions according to the present disclosure are pourable gels having a viscosity of at least 1,500 mPa·s but no more than 6,000 mPa·s, in one embodiment no more than 4,000 mPa·s, alternatively no more than 3,000 mPa·s, alternatively no more than 2,000 mPa·s.

Yet other compositions according to the present disclosure are non-pourable gels having a viscosity of at least 6,000 mPa·s but no more than 12,000 mPa·s, in one embodiment no more than 10,000 mPa·s, alternatively no more than 8,000 mPa·s and especially no more than 7,000 mPa·s.

In some embodiments, the fabric treatments herein include heavy-duty liquid laundry detergents for use in the wash cycle of automatic washing-machines and liquid fine wash and/or color care detergents; these suitably have the following rheological characteristics: viscosity of no more than 1,500 mPa·s, in one embodiment no more than 1,000 mPa·s, alternatively, no more than 500 mPa·s. Very suitable compositions have viscosity of from 150 to 400 mPa·s and are either Newtonian or shear-thinning.

In these definitions and unless specifically indicated to the contrary, all stated viscosities are those measured at a shear rate of 21 s-1 and at a temperature of 25° C. Viscosity herein can be measured with any suitable viscosity-measuring instrument, e.g., a Carrimed CSL2 Rheometer at a shear rate of 21 sec-1.

The fabric treatment compositions of the present disclosure may also contain suitable enzymes. In certain embodiments, the compositions of the present disclosure may contain less than about 1% of enzymes, alternatively, the compositions of the present disclosure may be substantially free of enzymes. As used herein “substantially free of enzymes” means that no enzymes are purposefully added to the formulation, but yet it is understood to one of ordinary skill in the art that trace amounts of enzymes may be present as impurities in other additives.

Where the compositions herein do contain enzymes, the enzymes should be selected from those that are compatible with an acid environment, including proteases, amylases, cellulose enzymes, lipases, mannanases, pectic lyase, subtilisin, and mixtures thereof. Examples of acid proteases include Promod® 24L, 144L and 671 L produced by Biocatalysts, and Protease A and Protease B produced by Amano and GC 106 and Fungal Acid Protease 500000 produced by Genencor. Other acid proteases are disclosed in U.S. Pat. Nos. 6,066,610 and 6,376,449. Amylases found to be functional under acidic washing conditions include Duramyl, Fungamyl and Natalase produced by Novozymes.

The fabric treatment compositions of the present disclosure may contain one or more additional laundry adjuncts such as dyes, hueing dyes, chelants, stabilizers, radical scavengers, perfumes, fluorescent whitening agents, suds-supressors, soil-suspension polymers, soil release polymers, dye-transfer inhibitors, fabric softening additives, rheology modifiers, and other polymers.

The fabric treatment compositions of the present disclosure may contain a dye to either provide a particular color to the composition itself (non-fabric substantive dyes) or to provide a hue to the fabric (hueing dyes). In one embodiment, the compositions of the present disclosure may contain from about 0.0001 to about 0.01% of a non-fabric substantive dye and/or a hueing dye.

Examples of hueing dyes useful herein include Basic Violet 3 (CI 42555) and Basic Violet 4 (CI 42600), both commercially available from Standard Dyes.

The fabric treatment compositions of the present disclosure may contain a bleaching agent. In one embodiment, the compositions of the present disclosure may contain from about 0.10% to about 10%, by weight of the composition, of a bleaching agent. Bleaching agents useful herein include hydrogen peroxide or peroxyacids such as 6-phthalimidoperoxyhexanoic acid.

The fabric treatment compositions of the present disclosure may contain a chelant. Chelants useful herein include DTPA, HEDP, DTPMP, dipicolinic acid, and mixtures thereof.

The fabric treatment compositions of the present disclosure may contain a radical scavenger which may be used with liquid hydrogen peroxide to provide stability. Radical scavengers useful herein include trimethoxybenzoic acid.

The fabric treatment compositions of the present disclosure may contain a fluorescent whitening agent. Fluorescent whitening agents useful herein include Tinopal CBS-X.

The fabric treatment compositions of the present disclosure may contain a suds suppressor. In one embodiment, the suds suppressor is a non-fatty acid suds suppressor. Examples of non-fatty acid suds supressors useful herein include silica/silicone type, silicone oil, alcohols such as branched alcohols, dimethicone, and mixtures thereof.

The fabric treatment compositions of the present disclosure may contain a soil suspension polymer. In one embodiment, the soil suspension polymer is selected from PEI ethoxylates, HMDA diquate ethoxylates, sulfonated derivatives, hydrophobically modified copolymers. Particularly preferred are PEI with MW=182 and an average degree of ethoxylation=15, PEI with MW=600 and an average degree of ethoxylation=20, hexamethylenediamine dimethyquat with an average degree of ethoxylation=24, and hexamethylenediamine dimethyquat with an average degree of ethoxylation=24 (disulfonated). In one aspect, the soil suspension polymer comprises diethylenetriamine pentaacetate, a modified cellulose, a polyvinyl alcohol such as PEG-136 polyvinyl alcohol, a propoxylated ethoxylated amine, a C12 to C18 sodium salt of a fatty acid, or mixtures thereof.

The fabric treatment compositions of the present disclosure may contain a soil release polymer. In one embodiment, the soil release polymer is a PET alkoxylate short block copolymer.

The fabric treatment compositions of the present disclosure may contain a dye transfer inhibitor and/or a dye fixative. Examples of dye transfer inhibitors useful herein include polyvinylpyrrolidone, poly-4-vinylpyridine-N-oxide, copolymers of N-vinyl-2-pyrrolidone and N-vinylimidazole and mixtures thereof.

In one aspect, the fabric treatment compositions of the present disclosure may contain a fabric softening additive. Examples of fabric softening additives useful herein include alkyl quaternary ammonium compounds, ester quaternary ammonium compounds, bentonite, silicones, cationic silicones, and mixtures thereof.

The fabric treatment compositions of the present disclosure may also contain a rheology modifier. Rheology modifiers useful herein include methylcellulose, hydroxypropylmethylcellulose, xanthan gum, gellan gum, guar gum and hydroxypropyl guar gum, succinoglycan, and trihydroxystearin. Particularly preferred are methylcellulose and hydroxypropylmethylcellulose thickeners available under the Methocel® trade name from Dow Chemical. When used herein, the detergent compositions of the present disclosure contain from about 0.01 to about 1%, by weight of the composition, of a rheology modifier. In one embodiment, the compositions herein contain from about 0.02 to about 0.75%, alternatively from about 0.05% to about 0.5%, by weight of the composition, of the rheology modifier.

The fabric treatment or laundry detergent of the present disclosure can also contain various wash or cleaning adjuvants. Possible wash or cleaning adjuvants include ethanolamine citrate, ethanolamine laurate, ethanolamine palmitate, ethanolamine oleate, ethanolamine stearate, C16 to C18 fatty acids, C18 unsaturated fatty acids, pentasodium pentetate, sodium laurate, sodium lauryl sulfate, sodium myristate, sodium oleate, sodium palmitate, sodium polyacrylate, sodium stearate, and mixtures thereof.

The fabric treatment or laundry detergent composition of the present disclosure can also contain various stabilizers and blending aids including calcium formate, diethylene glycol, dipropylene glycol, an alcohol, ethanol amine, glycerin, hydrogenated castor oil, monoethanol amine citrate, polyethylene glycol, sodium bisulfite, sodium carbonate, sodium citrate, sodium cumene sulfonate, sodium formate, sodium silicate, trimethylsiloxy silicate, or mixtures thereof.

The fabric treatment of the present disclosure can eliminate from about 50% to about 100% of the pathogens present on a fabric, such as soiled laundry. In some embodiments, the fabric treatment provided herein reduces the pathogenic load by eliminating of at least about 99.9% of the pathogens present on the fabrics. By “eliminating” is it understood and meant that the pathogens present are destroyed or have had their pathogenic threat destroyed or disabled. For example, elimination of pathogens may include disabling the ability of the pathogen to pose a pathogenic threat.

Provided herein are methods of laundering fabrics to provide reduction of pathogens from the laundered fabrics, where the method includes: a) introducing a fabric treatment to a wash water that can include a rinse water.

In one aspect, provided herein is a method for laundering fabrics comprising: placing the fabrics in a washing machine; running a laundry cycle on the fabrics in the washing machine, wherein the laundry cycle comprises a wash cycle having wash water and a rinse cycle having rinse water; providing a fabric treatment in accordance with the present disclosure to the washing machine during either the wash cycle or rinse cycle; and removing the fabrics from the washing machine upon completion of the laundry cycle.

When used as a hard or soft surface cleaner, the composition can be delivered to a surface to be cleaned, sanitized or disinfected by conventional means such as pouring the composition on a surface; a spray; which is applied to a surface via a spray means, including but not limited to, pump spray applicators, pressurized spray applicators and the like; a saturated wipe; a rag and a bucket; a mop and bucket; a sponge and a bucket; or via automated cleaning equipment and other similar and conventional ways to apply a composition to a surface for the purposes of sanitizing or disinfecting the surface.

To use the composition of the present disclosure, a surface is treated with the substrate by spraying, pouring, wiping or otherwise applying the composition to the surface. Once applied to the surface, the composition is allowed to remain on the surface for a period of time. The composition may be applied to the surface and allowed to dry or may alternatively be dried by wiping the surface with a dry wipe or wiping device.

Surfaces, which may be disinfected with the compositions include, but are not limited to, those located in dairies, homes, health care facilities, swimming pools, canneries, food processing plants, restaurants, hospitals, institutions, and industry, including secondary oil recovery. Hard surfaces, such as glass and polished aluminum, are particularly suited for application. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The compositions can also be used to sanitize floors, walls, furniture, mirrors, toilet fixtures, windows, and wood surfaces, such as fence rails, porch rails, decks, roofing, siding, window frames, and door frames. The compositions are particularly well suited for application on indirect food contact surfaces, such as cutting boards, utensils, containers, dishes, wash basins, appliances, and countertops. The compositions can be used to sanitize dairy plant equipment, milking machines, milk pails, tank trucks, and the like. Areas in hospitals would include beds, gurneys, tables, canisters, toilets, waste cans, stands, cabinets, shower stalls, floors, walls or any other non-porous surface.

One particularly useful application method is to impregnate the composition into a wipe substrate. In this embodiment, the wipe is a single use wipe that is impregnated with the disinfecting composition and is stored in a container that will dispense the wipe to a user. The container with the wipes may contain a single wipe, or several wipes. Suitable containers include a pouch containing a single wipe, such as a moist towelette which is torn open by the user or may be a pouch with a resealable opening containing several wipes in a stacked fashion, a rolled fashion or other suitable formation that would allow a single wipe to be removed from the opening at a time. Pouches are generally prepared from a fluid impervious material, such as a film, a coated paper or foil or other similar fluid impervious materials. In another way to dispense wipes of the present invention is to place the wipe into a fluid impervious container having an opening to access the wipes in the container. Containers may be molded plastic container with lids that are fluid impervious. Generally, the lid will have an opening to access the wipes in the container. The wipe in the container may be in a interleaved stack, such that as a wipe is removed from the container the next wipe is positioned in the opening of the container ready for the user to remove the next wipe. Alternatively, the wipe may be a continuous material which is perforated between the individual wipes of the continuous material. The continuous wipe material with perforations may be in a folded form or may be in a rolled form. Generally, in the rolled form, the wipe material is feed from the center of the rolled material. As with the interleaved stack, as a wipe is removed from the container, the next wipe is positioned in the opening for the use to remove the next wipe, when needed.

The disinfecting composition can be impregnated into the wipe such that the wipe is pre-moistened and will express or release the disinfecting composition on to the surface as the wipe is run across the surface to be treated. Generally, the disinfecting composition is saturated into the wipe such that the wipe will release the disinfecting composition to the surface through the wiping action.

Depending on the wipe substrate, saturation was generally achieved using about 3 weight parts of the use disinfecting composition per 1 weight part of the wipe substrate to be saturated. Generally, the disinfecting composition is used from about 4 parts to 6 parts by weight per 1 part by of the wiper substrate. In these ranges, complete saturation of the substrates can be achieved. It is noted that the amount of the disinfecting solution may go up or down to achieve complete saturation of the wipe substrate, depending on the particular wipe substrate.

Suitable wipe substrates include woven and nonwoven materials. Essentially any nonwoven web material may be used. Exemplary nonwoven materials may include, but are not limited to meltblown, coform, spunbond, airlaid, hydroentangled nonwovens, spunlace, bonded carded webs, and laminates thereof. Optionally, the nonwoven may be laminated with a film material as well. The fibers used to prepare the wipe substrate may be cellulosic fiber, thermoplastic fibers and mixtures thereof. The fibers may also be continuous fibers, discontinuous fibers, staple fibers and mixtures thereof. Basis weights of the nonwoven web may vary from about 12 grams per square meter to 200 grams per square meter or more.

In one embodiment the wipe is impregnated with a liquid component containing both active and inert ingredients within the allowable tolerance levels and the disinfecting composition expressed from the wipe contains active ingredients within the allowable tolerance levels. Once applied to the surface, the disinfecting composition is allowed to remain on the surface for a period of time. The composition may be applied to the surface and allowed to dry or may alternatively be dried by wiping the surface with a dry wipe or wiping device, which is preferably unused.

When the wipe or disinfecting composition of the present invention is used to wipe a surface, disinfection is achieved in less than 4 minutes, generally 3 minutes or less, 90 seconds or less, or even 60 seconds or less. It will be understood by those of ordinary skill that the antimicrobial disinfecting composition remains in contact with the surface requiring disinfection for a time sufficient to cause disinfection to occur.

In yet another embodiment, the composition may be used as a hand sanitizer. When used as a hand sanitizer, the antimicrobial agents of the present disclosure can be combined with any of the ingredients described above. In one embodiment, for instance, the antimicrobial agents may be combined with a solvent, such as water and/or an alcohol. In one particular application, a foaming agent may be added that causes the composition to foam when pumped from a dispenser. The foaming agent may comprise any suitable foaming agent that is compatible with the antimicrobial agents. In one embodiment, for instance, the foaming agent may comprise a dimethicone or other similar agents that may cause the hand sanitizer to foam.

In one embodiment, the composition may be used for disinfection of instruments, such as for pre-cleaning and disinfection or for terminal, high-level disinfection of a device, medical instrument or endoscope. In one embodiment, when the instrument is treated in a manual process, the composition can be applied by immersing the instrument in the appropriate concentration of the composition. For instance, plastic or metal containers, stainless steel sinks, or any other suitable container may be used as a vessel to hold the composition. In one embodiment, complete immersion of the instrument or device or endoscope, including voids, lumens and hollow sections, may be necessary. When used for disinfection of instruments such as endoscopes, the channels of the endoscope and other instruments may need to be flushed. In general, after disinfection the instrument must be rinsed and flushed thoroughly with water, preferably with significant quantities of water.

Various different microorganisms may be killed or controlled in accordance with the present disclosure. For instance, the composition of the present disclosure can control gram positive bacteria, gram negative bacteria, and the like. In addition to bacteria, the composition of the present disclosure can also kill and control the growth of various other microorganisms, such as viruses, fungi, spores, mycobacteria, and the like. Examples of particular microorganisms that may be killed or controlled in accordance with the present disclosure include Staphylococcus aureus, Streptococcus pneumoniae, Pseudomonas aeruginosa, Serratia marcescens, Salmonella enteritidis, Neisseria gonorrhoeae, Escherichia coli, Enterococcus hirae, Acinetobacter baumannii, Listeria monocytogenes, Pluralibacter gergoviae, Klebsiella pneumoniae, Burholderia cepacia, Pseudomonas putida, Kocuria rhizophila, Candida albicans, Saccharomyces cerevisiae, Aspergillus brasiliensis, Penicillium funiculosum, Eupenicillium levitum, Bacillus cereus, Bacillus subtilis, Clostridium difficile, Clostridium perfringens, Mycobacterium tuberculosis, Mycobacterium terrae, Mycobacterium avium, Poliovirus, Adenovirus, Norovirus, Vaccinia virus, Influenza virus, Hepatitis B virus, Human Immunodeficiency virus, Human papilloma virus, or mixtures thereof.

As described above, the surfactant of the present disclosure can improve the wetting and cleaning properties of the composition without decreasing the efficacy of the one or more antimicrobial agents. For example, the composition of the present disclosure can exhibit at least a 2 log reduction, such as a 3 log reduction, such as a 4 log reduction, such as even a 5 log reduction against any of the microorganisms identified above when tested according to Test EN1276 after a contact time of 60 seconds, 30 seconds, or even 20 seconds or according to Test EN1650 after a contact time of 5 minutes. Both tests can be conducted with distilled water. Further, it was unexpectedly discovered that the efficacy of the antimicrobial agent is not decreased in the presence of the surfactant. In other words, the composition is formulated to exhibit a log reduction when tested against a microorganism according to either Test EN1276 (contact time of 60 seconds) or Test EN1650 (contact time of 5 minutes) and wherein the log reduction is no less in comparison to an identical composition not containing the surfactant (surfactant replaced with water). The microorganism can be a bacteria, a virus, a fungi, or the like. In one aspect, the microorganism can be Pseudomonas aeruginosa or Candida albicans.

The present disclosure may be better understood with reference to the following examples. In the examples below, for surfactant mixtures containing an ethoxylated quaternary amine blended with an ethoxylated tertiary amine, the relative amounts of the components was determined by NMR spectroscopy or provided by the manufacturer unless otherwise denoted.

### Example No. 1

The following example demonstrates some of the advantages and benefits of the present disclosure. In particular, during this example, different surfactants were tested in combination with quaternary ammonium compounds to determine if the surfactant interferes with the antimicrobial efficacy of the quaternary ammonium compounds. The following example demonstrates some of the unexpected benefits and results achieved using surfactants made in accordance with the present disclosure.

More particularly, various different surfactants were combined with a quaternary ammonium compound and tested against a bacteria strain and a fungal strain in order to determine antimicrobial efficacy at different concentrations. The bacteria used in the examples was Pseudomonas aeruginosa and the fungal strain tested was Candida albicans. The bacteria were tested according to Test EN1276 with a contact time of 60 seconds, while the fungal test was conducted according to Test EN1650 with a contact time of 5 minutes.

The following test conditions were used:

TABLE NO 1

| | |
|---|---|
| Contact time(s): | 60 Seconds (bacteria) & 5 minutes (yeast) |
| Interfering substance: | Clean Medical conditions (0.3 g/L Bovine |
| | albumin) |
| Test conditions: | 22.5° C. ± 2.5° C. |
| Incubation conditions: | Bacteria: 37 ± 1° C. 24 hours |
| | Fungi: 30 ± 1° C. 42 hours |
| Culture media: | Bacteria: Tryptone soy agar |
| | Fungi: Malt extract agar |
| Neutraliser: | DE Broth |

Microbial test strains:

| | |
|---|---|
| Bacteria inoculum(s): | Pseudomonas aeruginosa (ATCC 15442) |
| Fungal inoculum(s): | Candida albicans (ATCC 10231) |

Candida albicans was subcultured, and incubated at 30±1° C. for 42-48 hours. Prior to testing, a second subculture was performed and incubated at 30±1° C. for 42-48 hours.

Pseudomonas aeruginosa was sub-cultured, and incubated at 37±1° C. for 18-24 hours. Prior to testing, a second subculture was performed and incubated at 37±1° C. for 18-24 hours.

Each test strain was harvested with suitable diluent. The obtained suspension cultures were standardized to yield approximately 10⁷ cfu/ml for Candida albicans and 10⁸ cfu/ml for Pseudomonas aeruginosa. Each test culture suspension was enumerated prior to testing.

Each test product was prepared at 1.25× concentration in distilled water.

Interfering substance (0.3 g/L Bovine Albumin) was added to test culture suspension for 2 minutes at a ratio of 1:1. The test product was added to the suspension for required contact time at a ratio of 4:1. After contact time an aliquot is immersed into chosen neutralizer at a ratio of 1:9. Ten fold serial dilutions of each test mixture was performed and a fixed volume was enumerated, allowing viability reduction of the organisms after exposure to be calculated.

The following surfactants were tested:
Sample No. 1: C12 to C14 alcohol with 7 mols of ethoxylate (cas no. 68439-50-9)
Sample No. 2: Secondary C12 to C14 alcohol containing 7 mols of ethoxylate groups (cas no. 84133-50-6)
Sample No. 3: Mixture containing 75% by weight quaternary ethoxylated cocoalkyl-2-hydroxyethylamine, chloride containing 20 mols of ethoxylate groups and 25% by weight ethoxylated cocoalkyl-2-hydroxyethylamine also containing 20 mols ethoxylate. The alkyl distribution is 4% C8, 5% C10, 54% C12, 18% C14, 10% C16, and 9% C18.

The antimicrobial agents tested were as follows:
Antimicrobial No. 1: N,N,-didecyl-N,N-dimethyl ammonium chloride
Antimicrobial No. 2: 40% octyl decyl dimethyl ammonium chloride, 16% dioctyl dimethyl ammonium chloride, and 24% didecyl dimethyl ammonium chloride

The following results were obtained:

Comparison of the Efficacy of Antimicrobial No. 1 Against P. aeruginosa and C. albicans with Different Surfactants

TABLE NO 2

| | P. aeruginosa (60 Sec) | | | C. albicans (5 min) | | |
|---|---|---|---|---|---|---|
| | Innoculum conc. - 4.4 × 10⁷ | | | Innoculum conc- 3.75 × 10⁶ | | |
| | cfu/ml | | | cfu/ml | | |
| | Sample | Sample | Sample | Sample | Sample | Sample |
| Antimicrobial | No. 1 | No. 2 | No. 3 | No. 1 | No. 2 | No. 3 |
| No. 1 | 10000 | 10000 | 10000 | 20000 | 20000 | 20000 |
| Concentration | ppm | ppm | ppm | ppm | ppm | ppm |
| 0 ppm | <3.12 | <3.12 | <3.27 | <2.06 | <2.06 | <2.06 |
| 500 ppm | — | <3.12 | >5.64 | <2.06 | <2.06 | >4.43 |
| 1000 ppm | <3.12 | 3.15 | >5.64 | 3.21 | >4.43 | >4.43 |
| 1500 ppm | <3.12 | 3.44 | >5.64 | 4.27 | >4.43 | >4.43 |
| 2000 ppm | >5.50 | 4.15 | >5.64 | >4.43 | >4.43 | >4.43 |
| 2500 ppm | >5.50 | >5.50 | >5.64 | >4.43 | >4.43 | >4.43 |

Comparison of the Efficacy of Antimicrobial No. 2 Against P. aeuginosa and C. albicans with Different Surfactants

TABLE NO 3

| | P. aeruginosa (60 Sec) | | | C. albicans (5 min) | | |
|---|---|---|---|---|---|---|
| | Innoculum conc. - 4.4 × 10⁷ | | | Innoculum conc- 3.75 × 10⁶ | | |
| | cfu/ml | | | cfu/ml | | |
| | Sample | Sample | Sample | Sample | Sample | Sample |
| Antimicrobial | No. 1 | No. 2 | No. 3 | No. 1 | No. 2 | No. 3 |
| No. 2 | 10000 | 10000 | 10000 | 20000 | 20000 | 20000 |
| Concentration | ppm | ppm | ppm | ppm | ppm | ppm |
| 0 ppm | <3.12 | <3.12 | <3.27 | <2.06 | <2.06 | <2.06 |
| 500 ppm | — | <3.12 | >5.64 | <2.06 | 3.06 | >4.43 |
| 1000 ppm | <3.12 | <3.12 | >5.64 | >4.43 | >4.43 | >4.43 |
| 1500 ppm | <3.12 | 3.91 | >5.64 | >4.43 | >4.43 | >4.43 |
| 2000 ppm | >5.50 | >5.50 | >5.64 | >4.43 | >4.43 | >4.43 |
| 2500 ppm | >5.50 | 4.97 | >5.64 | >4.43 | >4.43 | >4.43 |

As shown above, the nonionic surfactants identified as Sample Nos. 1 and 2 both significantly interfered with the antimicrobial efficacy of the antimicrobial agent. The effect is more pronounced at lower concentrations of the antimicrobial agent. The surfactant of the present disclosure, however, did not interfere with the efficacy of the antimicrobial agents.

### Example No. 2

Example No. 1 was repeated with the same surfactants and antimicrobial agents. In this example, however, the test was conducted in hard water having a hardness of 375 ppm using test methods EN1276 (bacteria) and EN 1640 (fungi).

Below are the following conditions:

TABLE NO 4

| | |
|---|---|
| Contact time(s): | 5 minutes |
| Interfering substance: | Clean Medical conditions (0.3 g/L Bovine |
| | albumin) |
| Test conditions: | 22.5° C. ± 2.5° C. |
| Incubation conditions: | Bacteria: 37 ± 1° C. 24 hours |
| | Fungi: 30 ± 1° C. 42 hours |
| Culture media: | Bacteria: Tryptone soy agar |
| | Fungi: Malt extract agar |
| Neutraliser: | DE Broth |

Microbial test strains:

| | |
|---|---|
| Bacteria inoculum(s): | Pseudomonas aeruginosa (ATCC 15442) |
| Fungal inoculum(s): | Candida albicans (ATCC 10231) |

Candida albicans was subcultured, and incubated at 30±1° C. for 42-48 hours. Prior to testing, a second subculture was performed and incubated at 30±1° C. for 42-48 hours.

Pseudomonas aeruginosa was sub-cultured, and incubated at 37±1° C. for 18-24 hours. Prior to testing, a second subculture was performed and incubated at 37±1° C. for 18-24 hours.

Each test strain was harvested with suitable diluent. The obtained suspension cultures were standardized to yield approximately 10⁷ cfu/ml for Candida albicans and 10⁸ cfu/ml for Pseudomonas aeruginosa. Each test culture suspension was enumerated prior to testing.

Each test product was prepared at 1.25× concentration in water of standardized hardness (375 ppm).

Interfering substance (0.3 g/L Bovine Albumin) was added to test culture suspension for 2 minutes at a ratio of 1:1. The test product was added to the suspension for required contact time at a ratio of 4:1. After contact time an aliquot is immersed into chosen neutralizer at a ratio of 1:9. Ten fold serial dilutions of each test mixture was performed and a fixed volume was enumerated, allowing viability reduction of the organisms after exposure to be calculated.

The following results were obtained:

Comparison of the Efficacy of Antimicrobial No. 1 Against P. aeruginosa with Different Surfactants at 5 Minutes Contact Time

TABLE NO 5

| | P. aeruginosa (5 min) | | | |
|---|---|---|---|---|
| | Innoculum conc.-2.47 × 10⁸ CFU/ml | | | |
| Antimicrobial | | Sample | Sample | Sample |
| No. 1 | | No. 1 | No. 2 | No. 3 |
| Concentration | 0 ppm | 250 ppm | 250 ppm | 250 ppm |
| 300 ppm | >5.47 | <3.10 | <3.10 | 3.34 |
| 400 ppm | >5.47 | <3.10 | <3.10 | 4.06 |
| 500 ppm | >5.47 | <3.10 | <3.10 | >5.47 |

Comparison of the Efficacy of Antimicrobial No. 2 Against C. albicans with Different Surfactants at 5 Minutes Contact Time

TABLE No. 6

| | C. albicans (5 min) | | | |
|---|---|---|---|---|
| | Innoculum conc.−2.48 × 10⁷ CFU/ml | | | |
| | | Sample | Sample | Sample |
| Antimicrobial | | No. 1 | No. 2 | No. 3 |
| No. 2 | | 2500 | 2500 | 2500 |
| Concentration | 0 ppm | ppm | ppm | ppm |
| 0 ppm | <1.88 | <1.88 | <1.88 | <1.88 |
| 25 ppm | 2.47 | <1.88 | <1.88 | <1.88 |
| 50 ppm | >4.25 | <1.88 | <1.88 | <1.88 |
| 100 ppm | >4.25 | <1.88 | <1.88 | >4.25 |
| 150 ppm | >4.25 | <1.88 | <1.88 | >4.25 |
| 250 ppm | >4.25 | <1.88 | 2.16 | >4.25 |

As shown above, the nonionic surfactants interfered with the efficacy of the antimicrobial agents while the surfactant of the present disclosure did not show the same effect.

### Example No. 3

In this example, a suspension test was conducted in order to demonstrate some of the advantages and benefits of the present disclosure. In particular, various antimicrobial agents and mixtures were combined and tested with and without the surfactant of the present disclosure.

Test compounds were screened using a suspension test. Organisms used were Pseudomonas aeruginosa ATCC 15442 and Klebsiella pneumoniae subsp. Pneumoniae ATCC 4352. Bacteria were stored at −80° C. using Microbank™ beads (Prolab diagnostics). Cultures were prepared in 250 mL baffled shake flasks with 25 mL of Tryptic Soy Broth (TSB) using one bead. After 18+/−8 hours incubation at 37° C. and 150 rpm, the inocula are prepared for the test.

The inocula was prepared by diluting the bacteria to 2.5×10⁶ CFU/mL in Butterfield's phosphate buffered saline (PBS). Three levels of each test compound were prepared by serial two fold dilution in PBS. For each biological rep, the test compounds were tested at 3 levels in quadruplicate with one quadruplicate control with no test compound.

The test was performed by mixing the test compounds with the inocula (80:20 test compound:inocula) and allowing 1 minute before neutralizing the reaction by 10 fold dilution in Letheen broth. After neutralization of the test, a log reduction was calculated.

In the first set of tests, various different antimicrobial agents were tested in combination with a surfactant mixture containing 75% by weight quaternary ethoxylated cocoalkyl-2-hydroxyethylamine, chloride and 25% by weight ethoxylated cocoalkyl-2-hydroxyethylamine both containing 20 mols of ethoxylate groups. The antimicrobial concentrations were at 5 ppm, 2.5 ppm, and 1.25 ppm. The first set of tests were tested against Klebsiella pneumoniae. The surfactant concentration was constant at 62.5 ppm.

TABLE NO 7

| | | Avg. Log Kill | | | | | |
|---|---|---|---|---|---|---|---|
| | | ppm antimicrobial agent, | | | Antimicrobial agent | | |
| | | 62.5 ppm surfactant | | | only ppm | | |
| | Klebsiella pneumoniae | 5 | 2.5 | 1.25 | 5 | 2.5 | 1.25 |
| 1 | Didecyl dimethyl ammonium | 5.13 | 4.13 | 3.38 | 4.93 | 3.93 | 1.18 |
| | carbonate/bicarbonate | | | | | | |
| 2 | Didecyl dimethyl ammonium | 5.13 | 4.88 | 2.88 | 4.55 | 3.05 | 0.30 |
| | chloride | | | | | | |
| 3 | Alkyl dimethyl benzyl | 4.38 | 2.88 | 0.13 | 2.43 | 0.11 | 0.05 |
| | ammonium chloride mix | | | | | | |
| 4 | Alkyl dimethyl ammonium | 3.88 | 2.38 | 0.38 | 2.43 | 0.18 | 0.05 |
| | chloride mix | | | | | | |
| 5 | Chlorohexidine\|Didecyl | 5.13 | 5.13 | 2.13 | 4.93 | 2.93 | 0.30 |
| | dimethyl ammonium chloride | | | | | | |
| | (1:1) | | | | | | |
| 6 | Chlorohexidine\|Alkyl dimethyl | 4.63 | 2.63 | 0.38 | 4.30 | 0.74 | −0.07 |
| | benzyl ammonium chloride | | | | | | |
| | mix (1:1) | | | | | | |
| 7 | Chlorohexidine\|Alkyl dimethyl | 5.08 | 3.83 | 2.58 | 4.76 | 2.82 | 0.32 |
| | ammonium chloride mix (1:1) | | | | | | |
| 8 | Didecyl dimethyl ammonium | 5.08 | 3.58 | 0.83 | 3.95 | 1.14 | 0.01 |
| | chloride\|Alkyl dimethyl benzyl | | | | | | |
| | ammonium chloride mix (1:1) | | | | | | |
| 9 | Didecyl dimethyl ammonium | 4.83 | 3.83 | 2.08 | 4.51 | 1.64 | 0.20 |
| | chloride\|Alkyl dimethyl | | | | | | |
| | ammonium chloride mix (1:1) | | | | | | |
| 10 | Alkyl dimethyl benzyl | 4.58 | 1.83 | 0.58 | 2.57 | 0.39 | −0.18 |
| | ammonium chloride mix\|Alkyl | | | | | | |
| | dimethyl ammonium chloride | | | | | | |
| | mix (1:1) | | | | | | |
| 11 | Chlorohexidine\|Didecyl | 4.58 | 2.33 | 0.33 | 3.82 | 0.82 | 0.20 |
| | dimethyl ammonium chloride\| | | | | | | |
| | Alkyl dimethyl benzyl | | | | | | |
| | ammonium chloride mix | | | | | | |
| | (1:1:1) | | | | | | |
| 12 | Chlorohexidine\|Didecyl | 4.83 | 3.08 | 0.33 | 4.26 | 1.32 | 0.07 |
| | dimethyl ammonium | | | | | | |
| | chloride\|Alkyl dimethyl | | | | | | |
| | ammonium chloride mix | | | | | | |
| | (1:1:1) | | | | | | |
| 13 | ChlorohexidinelAlkyl dimethyl | 4.61 | 3.36 | 1.86 | 2.39 | 0.21 | 0.02 |
| | benzyl ammonium chloride | | | | | | |
| | mix\|Alkyl dimethyl | | | | | | |
| | ammonium chloride mix | | | | | | |
| | (1:1:1) | | | | | | |
| 14 | Didecyl dimethyl ammonium | 4.36 | 2.86 | 0.11 | 1.96 | 0.21 | −0.11 |
| | chloride\|Alkyl dimethyl benzyl | | | | | | |
| | ammonium chloride mix\|Alkyl | | | | | | |
| | dimethyl ammonium chloride | | | | | | |
| | mix (1:1:1) | | | | | | |
| 15 | Chlorohexidine\|Didecyl | 4.61 | 2.86 | 0.61 | 2.21 | 0.08 | 0.14 |
| | dimethyl ammonium | | | | | | |
| | chloride\|Alkyl dimethyl benzyl | | | | | | |
| | ammonium chloride mix\|Alkyl | | | | | | |
| | dimethyl ammonium chloride | | | | | | |
| | mix (1:1:1:1) | | | | | | |
| 16 | Chlorohexidine\|Didecyl | 5.11 | 4.61 | 2.36 | 2.83 | 0.21 | 0.14 |
| | dimethyl ammonium | | | | | | |
| | chloride\|Alkyl dimethyl benzyl | | | | | | |
| | ammonium chloride mix\|Alkyl | | | | | | |
| | dimethyl ammonium chloride | | | | | | |
| | mix (5:1:1:1) | | | | | | |
| 17 | Didecyl dimethyl ammonium | 4.36 | 3.86 | 0.61 | 2.58 | 0.33 | −0.04 |
| | chloride\|ChlorohexidinelAlkyl | | | | | | |
| | dimethyl benzyl ammonium | | | | | | |
| | chloride mix\|Alkyl dimethyl | | | | | | |
| | ammonium chloride mix | | | | | | |
| | (5:1:1:1) | | | | | | |
| 18 | Alkyl dimethyl benzyl | 4.61 | 2.36 | −0.14 | 1.02 | −0.23 | −0.04 |
| | ammonium chloride mix\| | | | | | | |
| | Chlorohexidine\|Didecyl | | | | | | |
| | dimethyl ammonium | | | | | | |
| | chloride\|Alkyl dimethyl | | | | | | |
| | ammonium chloride mix | | | | | | |
| | (5:1:1:1) | | | | | | |
| 19 | Alkyl dimethyl ammonium | 4.36 | 2.61 | 1.11 | 1.08 | −0.04 | 0.27 |
| | chloride mix\|Chlorohexidine\| | | | | | | |
| | Didecyl dimethyl ammonium | | | | | | |
| | chloride\|Alkyl dimethyl benzyl | | | | | | |
| | ammonium chloride mix | | | | | | |
| | (5:1:1:1) | | | | | | |

The alkyl dimethyl benzyl ammonium chloride mix contained a mixture of 50% by weight C14, 10% by weight C16, and 40% by weight C12 dimethyl benzyl ammonium chloride. The alkyl dimethyl ammonium chloride mix contained 40% octyl decyl dimethyl ammonium chloride, 16% dioctyl dimethyl ammonium chloride, and 24% didecyl dimethyl ammonium chloride.

The above tests were repeated using the same surfactant against Pseudomonas aeruginosa.

TABLE NO 8

| | | Avg. Log Kill | | | Antimicrobial | | |
|---|---|---|---|---|---|---|---|
| | | ppm antimicrobial agent, | | | agent only | | |
| | | 62.5 ppm surfactant | | | ppm | | |
| | Pseudomonas aeruginosa | 5 | 2.5 | 1.25 | 5 | 2.5 | 1.25 |
| 1 | Didecyl dimethyl ammonium | 4.54 | 4.54 | 4.54 | 4.89 | 4.39 | 1.56 |
| | carbonate/bicarbonate | | | | | | |
| 2 | Didecyl dimethyl ammonium | 4.54 | 4.54 | 4.54 | 4.89 | 3.64 | 0.97 |
| | chloride | | | | | | |
| 3 | Alkyl dimethyl benzyl | 4.54 | 4.54 | 3.04 | 4.64 | 0.97 | −0.03 |
| | ammonium chloride mix | | | | | | |
| 4 | Alkyl dimethyl ammonium | 4.54 | 3.79 | 1.79 | 3.22 | 0.64 | −0.19 |
| | chloride mix | | | | | | |
| 5 | ChlorohexidinelDidecyl | 4.54 | 4.54 | 3.29 | 4.89 | 2.72 | 0.39 |
| | dimethyl ammonium chloride | | | | | | |
| | (1:1) | | | | | | |
| 6 | Chlorohexidine\|Alkyl | 4.54 | 4.29 | 1.79 | 4.56 | 1.89 | −0.11 |
| | dimethyl benzyl ammonium | | | | | | |
| | chloride mix (1:1) | | | | | | |
| 7 | Chlorohexidine\|Alkyl | 4.50 | 4.50 | 4.50 | 4.04 | 1.96 | −0.21 |
| | dimethyl ammonium chloride | | | | | | |
| | mix (1:1) | | | | | | |
| 8 | Didecyl dimethyl ammonium | 4.50 | 4.50 | 4.50 | 3.63 | 0.63 | −0.21 |
| | chloride\|Alkyl dimethyl | | | | | | |
| | benzyl ammonium chloride | | | | | | |
| | mix (1:1) | | | | | | |
| 9 | Didecyl dimethyl ammonium | 4.50 | 4.50 | 4.25 | 2.88 | 0.38 | −0.21 |
| | chloride\|Alkyl dimethyl | | | | | | |
| | ammonium chloride mix (1:1) | | | | | | |
| 10 | Alkyl dimethyl benzyl | 4.50 | 4.50 | 2.50 | 1.79 | −0.21 | −0.13 |
| | ammonium chloride mix\|Alkyl | | | | | | |
| | dimethyl ammonium chloride | | | | | | |
| | mix (1:1) | | | | | | |
| 11 | ChlorohexidinelDidecyl | 4.50 | 4.50 | 3.25 | 3.04 | 0.38 | −0.04 |
| | dimethyl ammonium chloride\| | | | | | | |
| | Alkyl dimethyl benzyl | | | | | | |
| | ammonium chloride mix | | | | | | |
| | (1:1:1) | | | | | | |
| 12 | ChlorohexidinelDidecyl | 4.50 | 4.50 | 4.25 | 2.79 | 0.46 | 0.13 |
| | dimethyl ammonium | | | | | | |
| | chloride\|Alkyl dimethyl | | | | | | |
| | ammonium chloride mix | | | | | | |
| | (1:1:1) | | | | | | |
| 13 | ChlorohexidinelAlkyl dimethyl | 4.61 | 4.61 | 4.61 | 3.66 | 1.16 | −0.51 |
| | benzyl ammonium chloride | | | | | | |
| | mix\|Alkyl dimethyl | | | | | | |
| | ammonium chloride mix | | | | | | |
| | (1:1:1) | | | | | | |
| 14 | Didecyl dimethyl ammonium | 4.61 | 4.61 | 3.11 | 2.66 | 0.66 | −0.26 |
| | chloride\|Alkyl dimethyl | | | | | | |
| | benzyl ammonium chloride | | | | | | |
| | mix\|Alkyl dimethyl | | | | | | |
| | ammonium chloride mix | | | | | | |
| | (1:1:1) | | | | | | |
| 15 | ChlorohexidinelDidecyl | 4.61 | 4.61 | 2.36 | 1.82 | 0.24 | −0.34 |
| | dimethyl ammonium | | | | | | |
| | chloride\|Alkyl dimethyl | | | | | | |
| | benzyl ammonium chloride | | | | | | |
| | mix\|Alkyl dimethyl | | | | | | |
| | ammonium chloride mix | | | | | | |
| | (1:1:1:1) | | | | | | |
| 16 | ChlorohexidinelDidecyl | 4.61 | 4.61 | 3.11 | 3.32 | 0.74 | −0.01 |
| | dimethyl ammonium | | | | | | |
| | chloride\|Alkyl dimethyl | | | | | | |
| | benzyl ammonium chloride | | | | | | |
| | mix\|Alkyl dimethyl | | | | | | |
| | ammonium chloride mix | | | | | | |
| | (5:1:1:1) | | | | | | |
| 17 | Didecyl dimethyl ammonium | 4.61 | 4.61 | 2.36 | 2.57 | 0.32 | −0.01 |
| | chloride\|Chlorohexidine\| | | | | | | |
| | Alkyl dimethyl benzyl | | | | | | |
| | ammonium chloride mix\|Alkyl | | | | | | |
| | dimethyl ammonium chloride | | | | | | |
| | mix (5:1:1:1) | | | | | | |
| 18 | Alkyl dimethyl benzyl | 4.61 | 4.36 | 1.61 | 1.49 | −0.01 | −0.26 |
| | ammonium chloride mix\| | | | | | | |
| | Chlorohexidine\|Didecyl | | | | | | |
| | dimethyl ammonium | | | | | | |
| | chloride\|Alkyl dimethyl | | | | | | |
| | ammonium chloride mix | | | | | | |
| | (5:1:1:1) | | | | | | |
| 19 | Alkyl dimethyl ammonium | 3.86 | 2.11 | 0.86 | 1.48 | 0.14 | 0.14 |
| | chloride mix\|Chlorohexidine\| | | | | | | |
| | Didecyl dimethyl ammonium | | | | | | |
| | chloride\|Alkyl dimethyl | | | | | | |
| | benzyl ammonium chloride | | | | | | |
| | mix (5:1:1:1) | | | | | | |

The alkyl dimethyl benzyl ammonium chloride mix contained a mixture of 50% by weight C14, 10% by weight C16, and 40% by weight C12 dimethyl benzyl ammonium chloride. The alkyl dimethyl ammonium chloride mix contained 40% octyl decyl dimethyl ammonium chloride, 16% dioctyl dimethyl ammonium chloride, and 24% didecyl dimethyl ammonium chloride.

The above tests were repeated. In the following tests, however, the surfactant used was a surfactant mixture containing 30% by weight quaternary ethoxylated stearyl-2-hydroxyethylamine, chloride containing 13 mols of ethoxylate groups and 70% by weight ethoxylated stearyl-2-hydroxyethylamine containing 13 mols of ethoxylate groups. The alkyl distribution was 90% C18, 10% less than C18, and 2% greater than C18. The above surfactant and antimicrobial agents were tested against Klebsiella pneumoniae and Pseudomonas aeruginosa. The following results were obtained.

TABLE NO 9

| | | Avg. Log Kill | | | | | |
|---|---|---|---|---|---|---|---|
| | | ppm antimicrobial | | | Antimicrobial | | |
| | | agent, 62.5 ppm | | | agent only | | |
| | | surfactant | | | ppm | | |
| | Klebsiella pneumoniae | 5 | 2.5 | 1.25 | 5 | 2.5 | 1.25 |
| 1 | Didecyl dimethyl ammonium | 4.46 | 3.46 | 3.46 | 4.93 | 3.93 | 1.18 |
| | carbonate/bicarbonate | | | | | | |
| 2 | Didecyl dimethyl ammonium | 4.46 | 4.71 | 2.96 | 4.55 | 3.05 | 0.30 |
| | chloride | | | | | | |
| 3 | Alkyl dimethyl benzyl | 4.21 | 2.71 | 2.46 | 2.43 | 0.11 | 0.05 |
| | ammonium chloride mix | | | | | | |
| 4 | Alkyl dimethyl ammonium | 4.21 | 2.46 | 1.96 | 2.43 | 0.18 | 0.05 |
| | chloride mix | | | | | | |
| 5 | ChlorohexidinelDidecyl | 4.96 | 4.96 | 2.71 | 4.93 | 2.93 | 0.30 |
| | dimethyl ammonium chloride | | | | | | |
| | (1:1) | | | | | | |
| 6 | Chlorohexidine\|Alkyl dimethyl | 4.96 | 3.46 | 2.21 | 4.30 | 0.74 | −0.07 |
| | benzyl ammonium chloride | | | | | | |
| | mix (1:1) | | | | | | |
| 7 | Chlorohexidine\|Alkyl dimethyl | 4.42 | 4.17 | 2.42 | 4.76 | 2.82 | 0.32 |
| | ammonium chloride mix (1:1) | | | | | | |
| 8 | Didecyl dimethyl ammonium | 3.92 | 3.92 | 2.17 | 3.95 | 1.14 | 0.01 |
| | chloride\|Alkyl dimethyl benzyl | | | | | | |
| | ammonium chloride mix (1:1) | | | | | | |
| 9 | Didecyl dimethyl ammonium | 4.17 | 4.42 | 2.42 | 4.51 | 1.64 | 0.20 |
| | chloride\|Alkyl dimethyl | | | | | | |
| | ammonium chloride mix (1:1) | | | | | | |
| 10 | Alkyl dimethyl benzyl\| | 3.92 | 2.17 | 1.17 | 2.57 | 0.39 | −0.18 |
| | ammonium chloride mixAlkyl | | | | | | |
| | dimethyl ammonium chloride | | | | | | |
| | mix (1:1) | | | | | | |
| 11 | Chlorohexidine\|Didecyl | 4.42 | 2.92 | 2.17 | 3.82 | 0.82 | 0.20 |
| | dimethyl ammonium chloride\| | | | | | | |
| | Alkyl dimethyl benzyl | | | | | | |
| | ammonium chloride mix | | | | | | |
| | (1:1:1) | | | | | | |
| 12 | ChlorohexidinelDidecyl | 4.17 | 3.92 | 2.42 | 4.26 | 1.32 | 0.07 |
| | dimethyl ammonium | | | | | | |
| | chloride\|Alkyl dimethyl | | | | | | |
| | ammonium chloride mix | | | | | | |
| | (1:1:1) | | | | | | |
| 13 | ChlorohexidinelAlkyl dimethyl | 3.68 | 3.18 | 2.43 | 2.39 | 0.21 | 0.02 |
| | benzyl ammonium chloride | | | | | | |
| | mix\|Alkyl dimethyl ammonium | | | | | | |
| | chloride mix (1:1:1) | | | | | | |
| 14 | Didecyl dimethyl ammonium | 4.68 | 3.68 | 2.18 | 1.96 | 0.21 | −0.11 |
| | chloride\|Alkyl dimethyl benzyl | | | | | | |
| | ammonium chloride mix\|Alkyl | | | | | | |
| | dimethyl ammonium chloride | | | | | | |
| | mix (1:1:1) | | | | | | |
| 15 | Chlorohexidine\|Didecyl | 4.93 | 3.43 | 2.18 | 2.21 | 0.08 | 0.14 |
| | dimethyl ammonium | | | | | | |
| | chloride\|Alkyl dimethyl benzyl | | | | | | |
| | ammonium chloride mix\|Alkyl | | | | | | |
| | dimethyl ammonium chloride | | | | | | |
| | mix (1:1:1:1) | | | | | | |
| 16 | ChlorohexidinelDidecyl | 4.68 | 3.93 | 2.68 | 2.83 | 0.21 | 0.14 |
| | dimethyl ammonium | | | | | | |
| | chloride\|Alkyl dimethyl benzyl | | | | | | |
| | ammonium chloride mix\|Alkyl | | | | | | |
| | dimethyl ammonium chloride | | | | | | |
| | mix (5:1:1:1) | | | | | | |
| 17 | Didecyl dimethyl ammonium | 4.93 | 3.68 | 1.93 | 2.58 | 0.33 | −0.04 |
| | chloride\|ChlorohexidinelAlkyl | | | | | | |
| | dimethyl benzyl ammonium | | | | | | |
| | chloride mix\|Alkyl dimethyl | | | | | | |
| | ammonium chloride mix | | | | | | |
| | (5:1:1:1) | | | | | | |
| 18 | Alkyl dimethyl benzyl | 3.18 | 1.93 | 0.43 | 1.02 | −0.23 | −0.04 |
| | ammonium chloride mix\| | | | | | | |
| | ChlorohexidinelDidecyl | | | | | | |
| | dimethyl ammonium | | | | | | |
| | chloride\|Alkyl dimethyl | | | | | | |
| | ammonium chloride mix | | | | | | |
| | (5:1:1:1) | | | | | | |
| 19 | Alkyl dimethyl ammonium | 3.68 | 2.18 | 0.68 | 1.08 | −0.04 | 0.27 |
| | chloride mix\|Chlorohexidinel | | | | | | |
| | Didecyl dimethyl ammonium | | | | | | |
| | chloride\|Alkyl dimethyl benzyl | | | | | | |
| | ammonium chloride mix | | | | | | |
| | (5:1:1:1) | | | | | | |

TABLE NO 10

| | | Avg. Log Kill | | | | | |
|---|---|---|---|---|---|---|---|
| | | ppm antimicrobial | | | | | |
| | | agent, 62.5 ppm | | | Antimicrobial agent | | |
| | | surfactant | | | only ppm | | |
| | Pseudomonas aeruginosa | 5 | 2.5 | 1.25 | 5 | 2.5 | 1.25 |
| 1 | Didecyl dimethyl ammonium | 5.08 | 5.08 | 4.83 | 4.89 | 4.39 | 1.56 |
| | carbonate/bicarbonate | | | | | | |
| 2 | Didecyl dimethyl ammonium | 5.08 | 5.08 | 3.58 | 4.89 | 3.64 | 0.97 |
| | chloride | | | | | | |
| 3 | Alkyl dimethyl benzyl | 5.08 | 3.58 | 1.83 | 4.64 | 0.97 | −0.03 |
| | ammonium chloride mix | | | | | | |
| 4 | Alkyl dimethyl ammonium | 5.08 | 2.83 | 1.58 | 3.22 | 0.64 | −0.19 |
| | chloride mix | | | | | | |
| 5 | ChlorohexidinelDidecyl | 5.08 | 5.08 | 3.58 | 4.89 | 2.72 | 0.39 |
| | dimethyl ammonium chloride | | | | | | |
| | (1:1) | | | | | | |
| 6 | ChlorohexidinelAlkyl dimethyl | 5.08 | 4.83 | 2.83 | 4.56 | 1.89 | −0.11 |
| | benzyl ammonium chloride mix | | | | | | |
| | (1:1) | | | | | | |
| 7 | Chlorohexidine\|Alkyl dimethyl | 4.75 | 4.75 | 3.50 | 4.04 | 1.96 | −0.21 |
| | ammonium chloride mix (1:1) | | | | | | |
| 8 | Didecyl dimethyl ammonium | 4.75 | 4.75 | 3.00 | 3.63 | 0.63 | −0.21 |
| | chloride\|Alkyl dimethyl benzyl | | | | | | |
| | ammonium chloride mix (1:1) | | | | | | |
| 9 | Didecyl dimethyl ammonium | 4.75 | 4.75 | 3.00 | 2.88 | 0.38 | −0.21 |
| | chloride\|Alkyl dimethyl | | | | | | |
| | ammonium chloride mix (1:1) | | | | | | |
| 10 | Alkyl dimethyl benzyl | 4.75 | 3.25 | 1.75 | 1.79 | −0.21 | −0.13 |
| | ammonium chloride mix\|Alkyl | | | | | | |
| | dimethyl ammonium chloride | | | | | | |
| | mix (1:1) | | | | | | |
| 11 | Chlorohexidine\|Didecyl | 4.75 | 4.50 | 3.00 | 3.04 | 0.38 | −0.04 |
| | dimethyl ammonium chloride\| | | | | | | |
| | Alkyl dimethyl benzyl | | | | | | |
| | ammonium chloride mix (1:1:1) | | | | | | |
| 12 | ChlorohexidinelDidecyl | 4.75 | 4.75 | 3.00 | 2.79 | 0.46 | 0.13 |
| | dimethyl ammonium | | | | | | |
| | chloride\|Alkyl dimethyl | | | | | | |
| | ammonium chloride mix (1:1:1) | | | | | | |
| 13 | Chlorohexidine\|Alkyl dimethyl | 4.54 | 4.04 | 3.04 | 3.66 | 1.16 | −0.51 |
| | benzyl ammonium chloride | | | | | | |
| | mix\|Alkyl dimethyl ammonium | | | | | | |
| | chloride mix (1:1:1) | | | | | | |
| 14 | Didecyl dimethyl ammonium | 4.79 | 4.79 | 3.04 | 2.66 | 0.66 | −0.26 |
| | chloride\|Alkyl dimethyl benzyl | | | | | | |
| | ammonium chloride mix\|Alkyl | | | | | | |
| | dimethyl ammonium chloride | | | | | | |
| | mix (1:1:1) | | | | | | |
| 15 | Chlorohexidine\|Didecyl | 4.79 | 4.79 | 3.29 | 1.82 | 0.24 | −0.34 |
| | dimethyl ammonium | | | | | | |
| | chloride\|Alkyl dimethyl benzyl | | | | | | |
| | ammonium chloride mix\|Alkyl | | | | | | |
| | dimethyl ammonium chloride | | | | | | |
| | mix (1:1:1:1) | | | | | | |
| 16 | ChlorohexidinelDidecyl | 4.79 | 4.54 | 3.54 | 3.32 | 0.74 | −0.01 |
| | dimethyl ammonium | | | | | | |
| | chloride\|Alkyl dimethyl benzyl | | | | | | |
| | ammonium chloride mix\|Alkyl | | | | | | |
| | dimethyl ammonium chloride | | | | | | |
| | mix (5:1:1:1) | | | | | | |
| 17 | Didecyl dimethyl ammonium | 4.79 | 4.54 | 2.79 | 2.57 | 0.32 | −0.01 |
| | chloride\|Chlorohexidine\|Alkyl | | | | | | |
| | dimethyl benzyl ammonium | | | | | | |
| | chloride mix\|Alkyl dimethyl | | | | | | |
| | ammonium chloride mix | | | | | | |
| | (5:1:1:1) | | | | | | |
| 18 | Alkyl dimethyl benzyl | 4.29 | 3.79 | 1.79 | 1.49 | −0.01 | −0.26 |
| | ammonium chloride mix\| | | | | | | |
| | Chlorohexidine\|Didecyl | | | | | | |
| | dimethyl ammonium | | | | | | |
| | chloride\|Alkyl dimethyl | | | | | | |
| | ammonium chloride mix | | | | | | |
| | (5:1:1:1) | | | | | | |
| 19 | Alkyl dimethyl ammonium | 4.79 | 3.79 | 2.29 | 1.48 | 0.14 | 0.14 |
| | chloride mix\|Chlorohexidinel | | | | | | |
| | Didecyl dimethyl ammonium | | | | | | |
| | chloride\|Alkyl dimethyl benzyl | | | | | | |
| | ammonium chloride mix | | | | | | |
| | (5:1:1:1) | | | | | | |

The alkyl dimethyl benzyl ammonium chloride mix contained a mixture of 50% by weight C14, 10% by weight C16, and 40% by weight C12 dimethyl benzyl ammonium chloride. The alkyl dimethyl ammonium chloride mix contained 40% octyl decyl dimethyl ammonium chloride, 16% dioctyl dimethyl ammonium chloride, and 24% didecyl dimethyl ammonium chloride.

The above tests were then repeated. In the following tests, however, the surfactant tested was a surfactant mixture containing 36% by weight quaternary ethoxylated cocoalkyl-2-hydroxyethylamine, chloride containing 13 mols of ethoxylate groups and 64% by weight ethoxylated cocoalkyl-2-hydroxyethylamine containing 13 mols of ethoxylate groups. The tests were conducted against Klebsiella pneumoniae and Pseudomonas aeruginosa. The following results were obtained:

TABLE NO 11

| | | Avg. Log Kill | | | | | |
|---|---|---|---|---|---|---|---|
| | | ppm antimicrobial | | | Antimicrobial | | |
| | | agent, 62.5 ppm | | | agent only | | |
| | | surfactant | | | ppm | | |
| | Klebsiella pneumoniae | 5 | 2.5 | 1.25 | 5 | 2.5 | 1.25 |
| 1 | Didecyl dimethyl | 5.00 | 5.00 | 3.25 | 4.93 | 3.93 | 1.18 |
| | ammonium | | | | | | |
| | carbonate/bicarbonate | | | | | | |
| 2 | Didecyl dimethyl | 5.00 | 4.25 | 2.75 | 4.55 | 3.05 | 0.30 |
| | ammonium chloride | | | | | | |
| 3 | Alkyl dimethyl benzyl | 4.00 | 0.75 | 0.00 | 2.43 | 0.11 | 0.05 |
| | ammonium chloride mix | | | | | | |
| 4 | Alkyl dimethyl ammonium | 3.75 | 2.00 | 0.00 | 2.43 | 0.18 | 0.05 |
| | chloride mix | | | | | | |
| 5 | ChlorohexidinelDidecyl | 5.00 | 4.25 | 2.75 | 4.93 | 2.93 | 0.30 |
| | dimethyl ammonium | | | | | | |
| | chloride (1:1) | | | | | | |
| 6 | Chlorohexidine\|Alkyl | 5.00 | 2.75 | 0.25 | 4.30 | 0.74 | −0.07 |
| | dimethyl benzyl | | | | | | |
| | ammonium chloride mix | | | | | | |
| | (1:1) | | | | | | |
| 7 | ChlorohexidinelAlkyl | 4.33 | 3.83 | 2.58 | 4.76 | 2.82 | 0.32 |
| | dimethyl ammonium | | | | | | |
| | chloride mix (1:1) | | | | | | |
| 8 | Didecyl dimethyl | 5.08 | 3.08 | 0.58 | 3.95 | 1.14 | 0.01 |
| | ammonium chloride\|Alkyl | | | | | | |
| | dimethyl benzyl | | | | | | |
| | ammonium chloride mix | | | | | | |
| | (1:1) | | | | | | |
| 9 | Didecyl dimethyl | 5.08 | 4.08 | 1.83 | 4.51 | 1.64 | 0.20 |
| | ammonium chloride\|Alkyl | | | | | | |
| | dimethyl ammonium | | | | | | |
| | chloride mix (1:1) | | | | | | |
| 10 | Alkyl dimethyl benzyl | 3.58 | 0.33 | 0.33 | 2.57 | 0.39 | −0.18 |
| | ammonium chloride | | | | | | |
| | mix\|Alkyl dimethyl | | | | | | |
| | ammonium chloride mix | | | | | | |
| | (1:1) | | | | | | |
| 11 | ChlorohexidinelDidecyl | 4.83 | 2.83 | 0.58 | 3.82 | 0.82 | 0.20 |
| | dimethyl ammonium | | | | | | |
| | chloride\|Alkyl dimethyl | | | | | | |
| | benzyl ammonium | | | | | | |
| | chloride mix (1:1:1) | | | | | | |
| 12 | Chlorohexidine\|Didecyl | 5.08 | 4.08 | 1.58 | 4.26 | 1.32 | 0.07 |
| | dimethyl ammonium | | | | | | |
| | chloride\|Alkyl dimethyl | | | | | | |
| | ammonium chloride mix | | | | | | |
| | (1:1:1) | | | | | | |
| 13 | ChlorohexidinelAlkyl | 4.43 | 3.43 | 2.43 | 2.39 | 0.21 | 0.02 |
| | dimethyl benzyl | | | | | | |
| | ammonium chloride | | | | | | |
| | mix\|Alkyl dimethyl | | | | | | |
| | ammonium chloride mix | | | | | | |
| | (1:1:1) | | | | | | |
| 14 | Didecyl dimethyl | 4.93 | 2.93 | 0.18 | 1.96 | 0.21 | −0.11 |
| | ammonium chloride\|Alkyl | | | | | | |
| | dimethyl benzyl | | | | | | |
| | ammonium chloride | | | | | | |
| | mix\|Alkyl dimethyl | | | | | | |
| | ammonium chloride mix | | | | | | |
| | (1:1:1) | | | | | | |
| 15 | Chlorohexidine\|Didecyl | 4.93 | 2.68 | 0.18 | 2.21 | 0.08 | 0.14 |
| | dimethyl ammonium | | | | | | |
| | chloride\|Alkyl dimethyl | | | | | | |
| | benzyl ammonium | | | | | | |
| | chloride mix\|Alkyl | | | | | | |
| | dimethyl ammonium | | | | | | |
| | chloride mix (1:1:1:1) | | | | | | |
| 16 | ChlorohexidinelDidecyl | 4.68 | 3.43 | 2.18 | 2.83 | 0.21 | 0.14 |
| | dimethyl ammonium | | | | | | |
| | chloride\|Alkyl dimethyl | | | | | | |
| | benzyl ammonium | | | | | | |
| | chloride mix\|Alkyl | | | | | | |
| | dimethyl ammonium | | | | | | |
| | chloride mix (5:1:1:1) | | | | | | |
| 17 | Didecyl dimethyl | 4.93 | 2.93 | 1.68 | 2.58 | 0.33 | −0.04 |
| | ammonium chloride\| | | | | | | |
| | Chlorohexidine Alkyl | | | | | | |
| | dimethyl benzyl | | | | | | |
| | ammonium chloride | | | | | | |
| | mix\|Alkyl dimethyl | | | | | | |
| | ammonium chloride mix | | | | | | |
| | (5:1:1:1) | | | | | | |
| 18 | Alkyl dimethyl benzyl | 4.43 | 1.68 | −0.07 | 1.02 | −0.23 | −0.04 |
| | ammonium chloride mix\| | | | | | | |
| | Chlorohexidine\|Didecyl | | | | | | |
| | dimethyl ammonium | | | | | | |
| | chloride\|Alkyl dimethyl | | | | | | |
| | ammonium chloride mix | | | | | | |
| | (5:1:1:1) | | | | | | |
| 19 | Alkyl dimethyl ammonium | 4.18 | 1.93 | −0.07 | 1.08 | −0.04 | 0.27 |
| | chloride mix\| | | | | | | |
| | Chlorohexidine\|Didecyl | | | | | | |
| | dimethyl ammonium | | | | | | |
| | chloride\|Alkyl dimethyl | | | | | | |
| | benzyl ammonium | | | | | | |
| | chloride mix (5:1:1:1) | | | | | | |

TABLE NO 12

| | | Avg. Log Kill | | | | | |
|---|---|---|---|---|---|---|---|
| | | ppm antimicrobial | | | | | |
| | | agent, 62.5 ppm | | | Antimicrobial agent | | |
| | | surfactant | | | only ppm | | |
| | Pseudomonas aeruginosa | 5 | 2.5 | 1.25 | 5 | 2.5 | 1.25 |
| 1 | Didecyl dimethyl ammonium | 4.58 | 4.58 | 3.08 | 4.89 | 4.39 | 1.56 |
| | carbonate/bicarbonate | | | | | | |
| 2 | Didecyl dimethyl ammonium | 4.58 | 4.58 | 3.33 | 4.89 | 3.64 | 0.97 |
| | chloride | | | | | | |
| 3 | Alkyl dimethyl benzyl | 4.33 | 1.58 | 0.08 | 4.64 | 0.97 | −0.03 |
| | ammonium chloride mix | | | | | | |
| 4 | Alkyl dimethyl ammonium | 4.33 | 1.33 | 0.33 | 3.22 | 0.64 | −0.19 |
| | chloride mix | | | | | | |
| 5 | Chlorohexidine\|Didecyl | 4.58 | 4.08 | 1.58 | 4.89 | 2.72 | 0.39 |
| | dimethyl ammonium chloride | | | | | | |
| | (1:1) | | | | | | |
| 6 | Chlorohexidine\|Alkyl dimethyl | 4.58 | 2.83 | 0.83 | 4.56 | 1.89 | −0.11 |
| | benzyl ammonium chloride | | | | | | |
| | mix (1:1) | | | | | | |
| 7 | ChlorohexidinelAlkyl dimethyl | 4.83 | 4.58 | 2.58 | 4.04 | 1.96 | −0.21 |
| | ammonium chloride mix (1:1) | | | | | | |
| 8 | Didecyl dimethyl ammonium | 4.83 | 4.08 | 2.33 | 3.63 | 0.63 | −0.21 |
| | chloride\|Alkyl dimethyl benzyl | | | | | | |
| | ammonium chloride mix (1:1) | | | | | | |
| 9 | Didecyl dimethyl ammonium | 4.83 | 4.08 | 1.83 | 2.88 | 0.38 | −0.21 |
| | chloride\|Alkyl dimethyl | | | | | | |
| | ammonium chloride mix (1:1) | | | | | | |
| 10 | Alkyl dimethyl benzyl | 4.33 | 1.33 | 0.33 | 1.79 | −0.21 | −0.13 |
| | ammonium chloride mix\|Alkyl | | | | | | |
| | dimethyl ammonium chloride | | | | | | |
| | mix (1:1) | | | | | | |
| 11 | Chlorohexidine\|Didecyl | 4.83 | 3.58 | 1.58 | 3.04 | 0.38 | −0.04 |
| | dimethyl ammonium chloride\| | | | | | | |
| | Alkyl dimethyl benzyl | | | | | | |
| | ammonium chloride mix | | | | | | |
| | (1:1:1) | | | | | | |
| 12 | ChlorohexidinelDidecyl | 4.83 | 4.08 | 2.33 | 2.79 | 0.46 | 0.13 |
| | dimethyl ammonium | | | | | | |
| | chloride\|Alkyl dimethyl | | | | | | |
| | ammonium chloride mix | | | | | | |
| | (1:1:1) | | | | | | |
| 13 | Chlorohexidine\|Alkyl dimethyl | 4.82 | 4.57 | 2.32 | 3.66 | 1.16 | −0.51 |
| | benzyl ammonium chloride | | | | | | |
| | mix\|Alkyl dimethyl ammonium | | | | | | |
| | chloride mix (1:1:1) | | | | | | |
| 14 | Didecyl dimethyl ammonium | 4.82 | 3.82 | 1.07 | 2.66 | 0.66 | −0.26 |
| | chloride\|Alkyl dimethyl benzyl | | | | | | |
| | ammonium chloride mix\|Alkyl | | | | | | |
| | dimethyl ammonium chloride | | | | | | |
| | mix (1:1:1) | | | | | | |
| 15 | ChlorohexidinelDidecyl | 4.82 | 3.32 | 1.57 | 1.82 | 0.24 | −0.34 |
| | dimethyl ammonium | | | | | | |
| | chloride\|Alkyl dimethyl benzyl | | | | | | |
| | ammonium chloride mix\|Alkyl | | | | | | |
| | dimethyl ammonium chloride | | | | | | |
| | mix (1:1:1:1) | | | | | | |
| 16 | ChlorohexidinelDidecyl | 4.57 | 4.82 | 2.07 | 3.32 | 0.74 | −0.01 |
| | dimethyl ammonium | | | | | | |
| | chloride\|Alkyl dimethyl benzyl | | | | | | |
| | ammonium chloride mix\|Alkyl | | | | | | |
| | dimethyl ammonium chloride | | | | | | |
| | mix (5:1:1:1) | | | | | | |
| 17 | Didecyl dimethyl ammonium | 4.82 | 4.57 | 1.07 | 2.57 | 0.32 | −0.01 |
| | chloride\|ChlorohexidinelAlkyl | | | | | | |
| | dimethyl benzyl ammonium | | | | | | |
| | chloride mix\|Alkyl dimethyl | | | | | | |
| | ammonium chloride mix | | | | | | |
| | (5:1:1:1) | | | | | | |
| 18 | Alkyl dimethyl benzyl | 4.57 | 1.32 | 0.32 | 1.49 | −0.01 | −0.26 |
| | ammonium chloride mix\| | | | | | | |
| | ChlorohexidinelDidecyl | | | | | | |
| | dimethyl ammonium | | | | | | |
| | chloride\|Alkyl dimethyl | | | | | | |
| | ammonium chloride mix | | | | | | |
| | (5:1:1:1) | | | | | | |
| 19 | Alkyl dimethyl ammonium | 4.57 | 1.32 | 1.07 | 1.48 | 0.14 | 0.14 |
| | chloride mix\| | | | | | | |
| | ChlorohexidinelDidecyl | | | | | | |
| | dimethyl ammonium | | | | | | |
| | chloride\|Alkyl dimethyl benzyl | | | | | | |
| | ammonium chloride mix | | | | | | |
| | (5:1:1:1) | | | | | | |

The alkyl dimethyl benzyl ammonium chloride mix contained a mixture of 50% by weight C14, 10% by weight C16, and 40% by weight C12 dimethyl benzyl ammonium chloride. The alkyl dimethyl ammonium chloride mix contained 40% octyl decyl dimethyl ammonium chloride, 16% dioctyl dimethyl ammonium chloride, and 24% didecyl dimethyl ammonium chloride.

As shown above, at low antimicrobial concentrations, the surfactant of the present disclosure did not adversely interfere with the efficacy of the antimicrobial agents. In fact, in many instances, the antimicrobial efficacy was enhanced.

### Example No. 4

The following experiments were conducted to demonstrate the cleaning properties of surfactants in accordance with the present disclosure.

In the following tests, various washing solutions were prepared containing a surfactant in accordance with the present disclosure combined with one or more quaternary ammonium antimicrobial agents. The antimicrobial agent was added to each sample in an amount of 0.02% by weight while the amount of surfactant varied. Each washing solution prepared was adjusted to a pH of 8 by adding a 6M hydrochloric acid solution.

Woven cotton fabrics and woven polyester fabrics were tested. The cloths were soaked in pure water for one day to remove any surfactants. The cloths were dried and then stained using a stain and finishing oil (“SFO”) or a light mineral oil (“LMO”).

During the test, the weight of the clean cloth was measured. Next, 30 mL SFO or LMO stain was deposited using an automatic micropipette. The weight of the stained cloth was measured again. The stained cloths were stored overnight for 16 hours at room temperature. The stained cloths were fixed with glass blocks a distance of about 1 cm above the bottom of an optical cuvette. The washing solution was poured in the cuvette and the release of oil from the soiled cloth was observed for 30 minutes.

The cloth was removed from the cuvette and suction was used to remove liquids and prevent oil redeposition. The cloth samples were dried at ambient temperature for one day and the weight was measured again. The difference between the weight of the dry cloth before and after washing yields the mass of oil that was removed.

In the first set of experiments, the surfactant used was a surfactant mixture containing 75% by weight quaternary ethoxylated cocoalkyl-2-hydroxyethylamine, chloride containing 20 mols of ethoxylate groups and 25% by weight ethoxylated cocoalkyl-2-hydroxyethylamine containing 20 mols of ethoxylate groups. The following results were obtained:

TABLE No. 13

| | Woven | Woven | Woven | Woven |
|---|---|---|---|---|
| | Cotton | PE | Cotton | PE |
| | SFO | SFO | LMO | LMO |
| | % soil removal | | | |
| 0.20 wt % surfactant | 73 | 78 | 77 | 79 |
| 0.20 wt % surfactant + 0.02 wt % didecyl | 72 | 71 | 73 | 75 |
| dimethyl ammonium chloride | | | | |
| 0.10 wt % surfactant + 0.02 wt % didecyl | 51 | 49 | 44 | 68 |
| dimethyl ammonium chloride | | | | |
| 0.05 wt % surfactant + 0.02 wt % didecyl | 28 | 1 | 22 | 67 |
| dimethyl ammonium chloride | | | | |
| 0.20 wt % surfactant + 0.02 wt % 40% octyl | 74 | 56 | 64 | 69 |
| decyl dimethyl ammonium chloride, 16% | | | | |
| dioctyl dimethyl ammonium chloride, and | | | | |
| 24% didecyl dimethyl ammonium chloride | | | | |
| 0.10 wt % surfactant + 0.02 wt % 40% octyl | 63 | 49 | 38 | 39 |
| decyl dimethyl ammonium chloride, 16% | | | | |
| dioctyl dimethyl ammonium chloride, and | | | | |
| 24% didecyl dimethyl ammonium chloride | | | | |
| 0.05 wt % surfactant + 0.02 wt % 40% octyl | 22 | 3 | 28 | 30 |
| decyl dimethyl ammonium chloride, 16% | | | | |
| dioctyl dimethyl ammonium chloride, and | | | | |
| 24% didecyl dimethyl ammonium chloride | | | | |
| 0.01 wt % surfactant + 0.02 wt % 40% octyl | | | 21 | 12 |
| decyl dimethyl ammonium chloride, 16% | | | | |
| dioctyl dimethyl ammonium chloride, and | | | | |
| 24% didecyl dimethyl ammonium chloride | | | | |

As shown above, greater amounts of surfactant led to better cleaning properties.

The above example was repeated except the surfactant mixture contained 36% by weight quaternary ethoxylated cocoalkyl-2-hydroxyethylamine, chloride containing 13 mols of ethoxylate groups and 64% by weight ethoxylated cocoalkyl-2-hydroxyethylamine containing 13 mols of ethoxylate groups. The following results were obtained:

TABLE No. 14

| | Woven | Woven | Woven | Woven |
|---|---|---|---|---|
| | Cotton | PE | Cotton | PE |
| | SFO | SFO | LMO | LMO |
| | % soil removal | | | |
| 0.20 wt % surfactant | 62 | 66 | 71 | 67 |
| 0.20 wt % surfactant + 0.02 wt % didecyl | 65 | 62 | 72 | 64 |
| dimethyl ammonium chloride | | | | |
| 0.10 wt % surfactant + 0.02 wt % didecyl | 63 | 55 | 57 | 60 |
| dimethyl ammonium chloride | | | | |
| 0.05 wt % surfactant + 0.02 wt % didecyl | 24 | 42 | 25 | 50 |
| dimethyl ammonium chloride | | | | |
| 0.20 wt % surfactant + 0.02 wt % 40% octyl | 65 | 68 | 71 | 64 |
| decyl dimethyl ammonium chloride, 16% | | | | |
| dioctyl dimethyl ammonium chloride, and | | | | |
| 24% didecyl dimethyl ammonium chloride | | | | |
| 0.10 wt % surfactant + 0.02 wt % 40% octyl | 66 | 58 | 57 | 66 |
| decyl dimethyl ammonium chloride, 16% | | | | |
| dioctyl dimethyl ammonium chloride, and | | | | |
| 24% didecyl dimethyl ammonium chloride | | | | |
| 0.05 wt % surfactant + 0.02 wt % 40% octyl | 31 | 29 | 23 | 61 |
| decyl dimethyl ammonium chloride, 16% | | | | |
| dioctyl dimethyl ammonium chloride, and | | | | |
| 24% didecyl dimethyl ammonium chloride | | | | |
| 0.01 wt % surfactant + 0.02 wt % 40% octyl | | | 15 | 34 |
| decyl dimethyl ammonium chloride, 16% | | | | |
| dioctyl dimethyl ammonium chloride, and | | | | |
| 24% didecyl dimethyl ammonium chloride | | | | |

The above example was repeated using a surfactant mixture containing 33% by weight quaternary ethoxylated stearyl-2-hydroxyethylamine, chloride containing 20 mols of ethoxylate groups and 67% by weight ethoxylated stearyl-2-hydroxyethylamine containing 20 mols of ethoxylate groups. The following results were obtained:

TABLE No. 15

| | Woven | Woven | Woven | Woven |
|---|---|---|---|---|
| | Cotton | PE | Cotton | PE |
| | SFO | SFO | LMO | LMO |
| | % soil removal | | | |
| 0.20 wt % surfactant | 73 | 68 | 66 | 78 |
| 0.20 wt % surfactant + 0.02 wt % didecyl | 77 | 35 | 73 | 68 |
| dimethyl ammonium chloride | | | | |
| 0.10 wt % surfactant + 0.02 wt % didecyl | 66 | 19 | 73 | 68 |
| dimethyl ammonium chloride | | | | |
| 0.05 wt % surfactant + 0.02 wt % didecyl | 54 | 8 | 64 | 62 |
| dimethyl ammonium chloride | | | | |
| 0.20 wt % surfactant + 0.02 wt % 40% octyl | 79 | 43 | 77 | 72 |
| decyl dimethyl ammonium chloride, 16% | | | | |
| dioctyl dimethyl ammonium chloride, and | | | | |
| 24% didecyl dimethyl ammonium chloride | | | | |
| 0.10 wt % surfactant + 0.02 wt % 40% octyl | 71 | 21 | 69 | 61 |
| decyl dimethyl ammonium chloride, 16% | | | | |
| dioctyl dimethyl ammonium chloride, and | | | | |
| 24% didecyl dimethyl ammonium chloride | | | | |
| 0.05 wt % surfactant + 0.02 wt % 40% octyl | 67 | 6 | 68 | 28 |
| decyl dimethyl ammonium chloride, 16% | | | | |
| dioctyl dimethyl ammonium chloride, and | | | | |
| 24% didecyl dimethyl ammonium chloride | | | | |

Consistent with the other results, adding greater amounts of surfactant led to greater cleaning properties.

The above example was repeated except in this example the surfactant mixture contained 30% by weight a quaternary ethoxylated stearyl-2-hydroxyethylamine, chloride containing 13 mols of ethoxylate and 70% by weight ethoxylated stearyl-2-hydroxyethylamine containing 13 mols of ethoxylate. The following results were obtained:

TABLE No. 16

| | Woven | Woven | Woven | Woven |
|---|---|---|---|---|
| | Cotton | PE | Cotton | PE |
| | SFO | SFO | LMO | LMO |
| | % soil removal | | | |
| 0.20 wt % surfactant | 74 | 68 | 78 | 69 |
| 0.20 wt % surfactant + 0.02 wt % didecyl | 72 | 69 | 74 | 67 |
| dimethyl ammonium chloride | | | | |
| 0.10 wt % surfactant + 0.02 wt % didecyl | 73 | 68 | 75 | 67 |
| dimethyl ammonium chloride | | | | |
| 0.05 wt % surfactant + 0.02 wt % didecyl | 66 | 59 | 62 | 65 |
| dimethyl ammonium chloride | | | | |
| 0.20 wt % surfactant + 0.02 wt % 40% octyl | 72 | 67 | 76 | 69 |
| decyl dimethyl ammonium chloride, 16% | | | | |
| dioctyl dimethyl ammonium chloride, and | | | | |
| 24% didecyl dimethyl ammonium chloride | | | | |
| 0.10 wt % surfactant + 0.02 wt % 40% octyl | 67 | 62 | 72 | 68 |
| decyl dimethyl ammonium chloride, 16% | | | | |
| dioctyl dimethyl ammonium chloride, and | | | | |
| 24% didecyl dimethyl ammonium chloride | | | | |
| 0.05 wt % surfactant + 0.02 wt % 40% octyl | 63 | 56 | 62 | 60 |
| decyl dimethyl ammonium chloride, 16% | | | | |
| dioctyl dimethyl ammonium chloride, and | | | | |
| 24% didecyl dimethyl ammonium chloride | | | | |

### Example No. 5

The following experiments were conducted to further demonstrate the cleaning properties of surfactants in accordance with the present disclosure. In this example, mixtures of an ethoxylated quaternary amine and an ethoxylated tertiary amine were compared to an ethoxylated quaternary amine alone and an ethoxylated tertiary amine alone.

The following samples were formulated:
Sample No. 1: based on an ethoxylated stearyl-2-hydroxyethylamine containing 20 mols of ethoxylate groups. For Sample 1A, The alkyl distribution was 10% C16 or smaller, 90% C18, and 2% greater than C18. For samples 1B-1F, the alkyl distribution was >99% C18. The following mixtures were produced and verified by H¹ NMR:
   Sample No. 1A: 33% by weight quaternary ethoxylated stearyl-2-hydroxyethylamine, chloride and 67% by weight ethoxylated stearyl-2-hydroxyethylamine;
   Sample No. 1B: 100% by weight ethoxylated stearyl-2-hydroxyethylamine;
   Sample No. 1C: 17.9% by weight quaternary ethoxylated stearyl-2-hydroxyethylamine, chloride and 82.1% by weight ethoxylated stearyl-2-hydroxyethylamine;
   Sample No. 1D: 35.8% by weight quaternary ethoxylated stearyl-2-hydroxyethylamine, chloride and 64.3% by weight ethoxylated stearyl-2-hydroxyethylamine;
   Sample No. 1E: 53.6% by weight quaternary ethoxylated stearyl-2-hydroxyethylamine, chloride and 46.4% by weight ethoxylated stearyl-2-hydroxyethylamine;
   Sample No. 1F: about 71.5% by weight quaternary ethoxylated stearyl-2-hydroxyethylamine, 28.5% by weight ethoxylated stearyl-2-hydroxyethylamine.
Sample No. 2: based on an ethoxylated stearyl-2-hydroxyethylamine containing 15 mols of ethoxylate groups. The alkyl distribution was greater than 99% C18.
   Sample No. 2A: 100% by weight ethoxylated stearyl-2-hydroxyethylamine;
   Sample No. 2B: 25% by weight quaternary ethoxylated stearyl-2-hydroxyethylamine, chloride and 75% by weight ethoxylated stearyl-2-hydroxyethylamine (relative amount of surfactants calculated from reactants used to produce the surfactant blend);
   Sample No. 2C: 50% by weight quaternary ethoxylated stearyl-2-hydroxyethylamine, chloride and 50% by weight ethoxylated stearyl-2-hydroxyethylamine (relative amount of surfactants calculated from reactants used to produce the surfactant blend);
   Sample No. 2D: 75% by weight quaternary ethoxylated stearyl-2-hydroxyethylamine, chloride and 25% by weight ethoxylated stearyl-2-hydroxyethylamine (relative amount of surfactants calculated from reactants used to produce the surfactant blend);
   Sample No. 2E: about 100% by weight quaternary ethoxylated stearyl-2-hydroxyethylamine (100% amount calculated from reactants used to produce the surfactant).
Sample No. 3: based on an ethoxylated stearyl-2-hydroxyethylamine containing 10 mols of ethoxylate groups. The alkyl distribution was greater than 99% C18.
   Sample No. 3A: 100% by weight ethoxylated stearyl-2-hydroxyethylamine;
   Sample No. 3B: 25% by weight quaternary ethoxylated stearyl-2-hydroxyethylamine, chloride and 75% by weight ethoxylated stearyl-2-hydroxyethylamine (relative amount of surfactants calculated from reactants used to produce the surfactant blend);
   Sample No. 3C: 50% by weight quaternary ethoxylated stearyl-2-hydroxyethylamine, chloride and 50% by weight ethoxylated stearyl-2-hydroxyethylamine (relative amount of surfactants calculated from reactants used to produce the surfactant blend);
   Sample No. 3D: 75% by weight quaternary ethoxylated stearyl-2-hydroxyethylamine, chloride and 25% by weight ethoxylated stearyl-2-hydroxyethylamine (relative amount of surfactants calculated from reactants used to produce the surfactant blend);
   Sample No. 3E: about 100% by weight quaternary ethoxylated stearyl-2-hydroxyethylamine (100% amount calculated from reactants used to produce the surfactant).
Sample No. 4: based on an ethoxylated cocoalkyl-2-hydroxyethylamine containing 15 mols of ethoxylate groups. The alkyl distribution was 4% C8, 7% C10, 51% C12, 19% C14, 9% C16, 2% C18 and 6% C18:1.
   Sample No. 4A: 100% by weight ethoxylated cocoalkyl-2-hydroxyethylamine;
   Sample No. 4B: 25% by weight quaternary ethoxylated cocoalkyl-2-hydroxyethylamine, chloride and 75% by weight ethoxylated cocoalkyl-2-hydroxyethylamine (relative amount of surfactants calculated from reactants used to produce the surfactant blend);
   Sample No. 4C: 50% by weight quaternary ethoxylated cocoalkyl-2-hydroxyethylamine, chloride and 50% by weight ethoxylated cocoalkyl-2-hydroxyethylamine (relative amount of surfactants calculated from reactants used to produce the surfactant blend);
   Sample No. 4D: 75% by weight quaternary ethoxylated cocoalkyl-2-hydroxyethylamine, chloride and 25% by weight ethoxylated cocoalkyl-2-hydroxyethylamine (relative amount of surfactants calculated from reactants used to produce the surfactant blend);
   Sample No. 4E: about 100% by weight quaternary ethoxylated cocoalkyl-2-hydroxyethylamine (100% amount calculated from reactants used to produce the surfactant).

Each of the above samples were combined with a washing solution. The washing solution contained 200 ppm a mixture of 32% by weight of an alkyl dimethyl benzyl ammonium chloride mix (containing a mixture of 50% by weight C14, 10% by weight C16, and 40% by weight C12 dimethyl benzyl ammonium chloride) combined with 24% by weight octyl decyl dimethyl ammonium chloride, 9.6% by weight dioctyl dimethyl ammonium chloride, and 14.4% by weight didecyl dimethyl ammonium chloride; 250 ppm citric acid; 42 ppm triethanolamine; and 1000 ppm of the samples described above.

Woven cotton fabrics were tested. The cloths were stained using a mineral oil with carbon black (TestFabric Stain CFT-01-s).

Washing was carried out in a Rotawash M228B/C color fastness tester (SDL Atlas USA, Rock Hill, South Carolina) using large canisters, with 3 replicate stains per pot and 60 mL of diluted product in tap water (226 ppm hardness) at room temperature for one hour using 10 stainless steel beads.

Stain and fabric measurements, before and after washing were made with a BYK Spectro-guide 45/0 gloss spectrophotometer (BYK-Gardner GmbH, Geretsried, Germany). Each unwashed and washed stain was measured 5 times.

The Stain Removal Index (SRI) was calculated as described in ASTM 4265 Standard Guide for Evaluating Stain Removal Performance in Home Laundering.

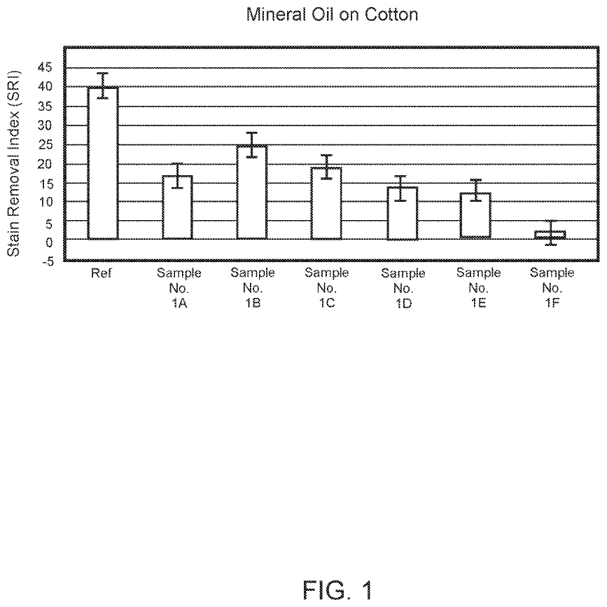

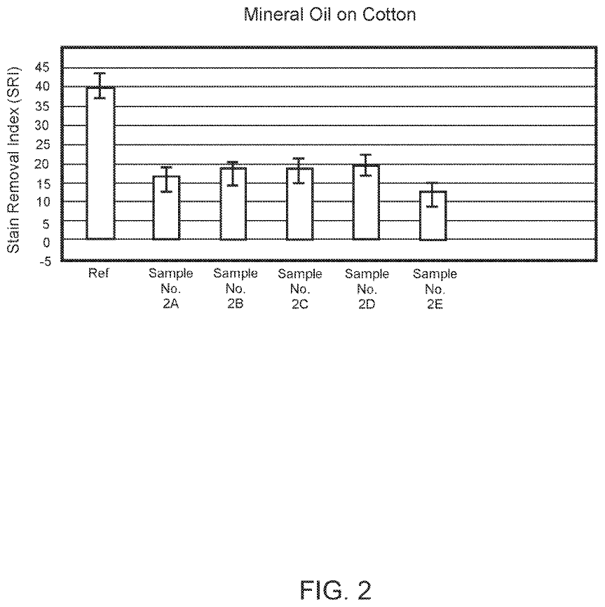

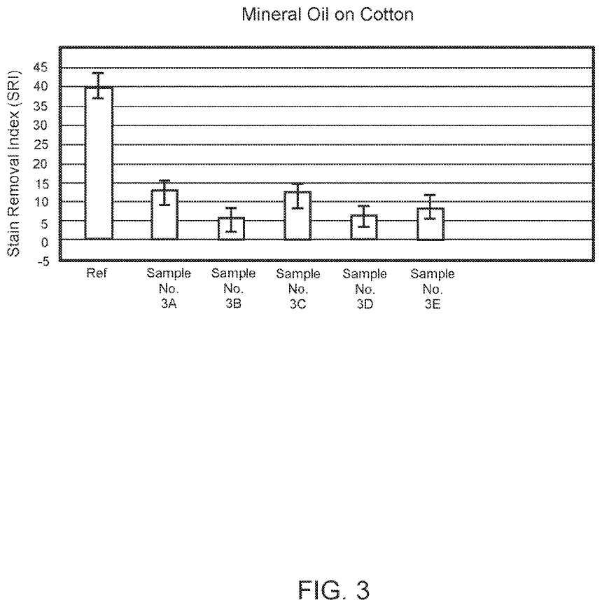

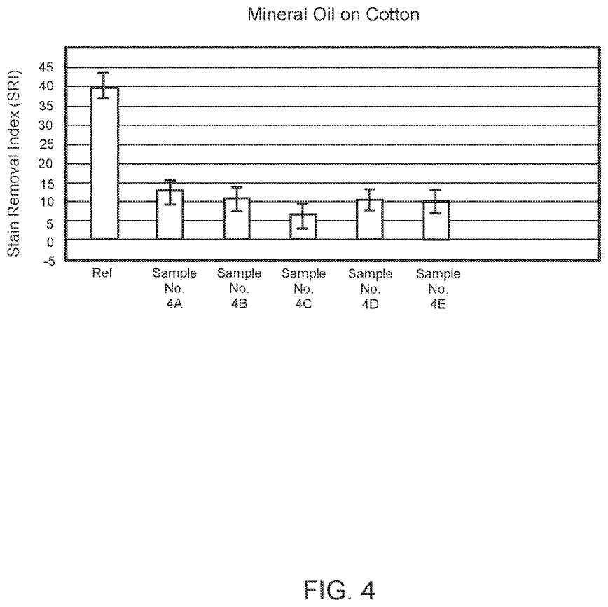

The results of Sample No. 1 are illustrated in FIG. 1. The results of Sample No. 2 are illustrated in FIG. 2. The results of Sample No. 3 are illustrated in FIG. 3. The results of Sample No. 4 are illustrated in FIG. 4.

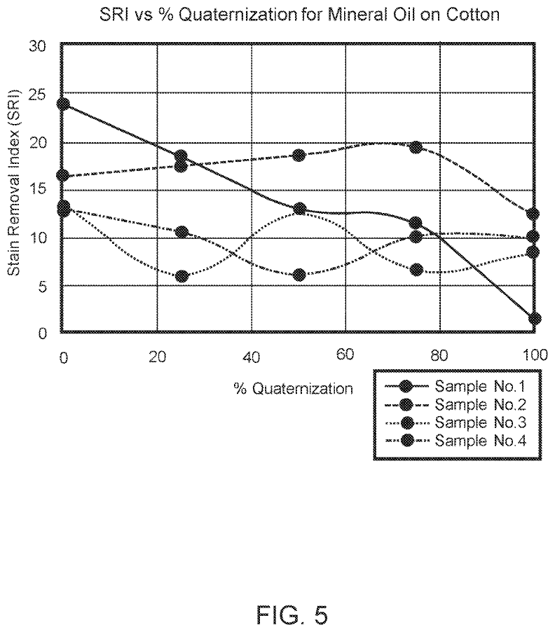

FIG. 5 graphically illustrates the results based on percent quaternization. As shown, including an amount of an ethoxylated tertiary amine can improve the Stain Removal Index. The ethoxylated quaternary amine, however, is believed to improve antimicrobial properties as demonstrated in the other examples.

### Example No. 6

In this example, a suspension test was conducted in order to demonstrate some of the advantages and benefits of the present disclosure. In particular, various antimicrobial agents were combined and tested with the surfactants of the present disclosure. In this example, mixtures of an ethoxylated quaternary amine and an ethoxylated tertiary amine were compared to an ethoxylated quaternary amine alone and an ethoxylated tertiary amine alone.

Test compounds were screened using a suspension test. The organism used was Klebsiella pneumoniae subsp. Pneumoniae ATCC 4352. Bacteria were stored at −80° C. using Microbank™ beads (Prolab diagnostics). Cultures were prepared in 250 mL baffled shake flasks with 25 mL of Tryptic Soy Broth (TSB) using one bead. After 18+/−8 hours incubation at 37° C. and 150 rpm, the inocula are prepared for the test.

The inocula was prepared by diluting the bacteria to 2.5×10⁶ CFU/mL in Butterfield's phosphate buffered saline (PBS). Three levels of each test compound were prepared by serial two fold dilution in PBS. For each biological rep, the test compounds were tested at 3 levels in quadruplicate with one quadruplicate control with no test compound.

The test was performed by mixing the test compounds with the inocula (80:20 test compound:inocula) and allowing 1 minute before neutralizing the reaction by 10 fold dilution in Letheen broth. After neutralization of the test, a log reduction was calculated.

Various different antimicrobial agents were tested in combination with Sample No. 1 and Sample No. 2 from Example No. 5. The antimicrobial concentrations were at 500 ppm and 250 ppm. The experiments were tested against Klebsiella pneumoniae. The surfactant concentration was constant at 1000 ppm.

In the tables below, the alkyl dimethyl benzyl ammonium chloride mix contained a mixture of 50% by weight C14, 10% by weight C16, and 40% by weight C12 dimethyl benzyl ammonium chloride. The alkyl dimethyl ammonium chloride mix contained 40% octyl decyl dimethyl ammonium chloride, 16% dioctyl dimethyl ammonium chloride, and 24% didecyl dimethyl ammonium chloride.

TABLE No. 17

| | | Log Kill | |
|---|---|---|---|
| | | Sample No. 1B | |
| | Klebsiella pneumoniae | 1000 ppm | |
| | Amount of antimicrobial | 500 ppm | 250 ppm |
| 1 | N,N-Didecyl-N-methyl- | 4.94 | 1.44 |
| | poly(oxyethyl) ammonium | | |
| | propionate | | |
| 2 | Chlorohexidine\|Didecyl | 4.94 | 3.19 |
| | dimethyl ammonium chloride | | |
| | (1:1) | | |
| 3 | Chlorohexidine\|Didecyl | 4.94 | 1.19 |
| | dimethyl ammonium | | |
| | chloride\|Alkyl dimethyl | | |
| | ammonium chloride mix | | |
| | (1:1:1) | | |
| 19 | Alkyl dimethyl ammonium | 4.94 | 0.94 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 18

| | | Log Kill | |
|---|---|---|---|
| | | Sample No. 1C | |
| | Klebsiella pneumoniae | 1000 ppm | |
| | Amount of antimicrobial | 500 ppm | 250 ppm |
| 1 | N,N-Didecyl-N-methyl- | 5.19 | 1.44 |
| | poly(oxyethyl) ammonium | | |
| | propionate | | |
| 2 | Chlorohexidine\|Didecyl | 5.19 | 1.44 |
| | dimethyl ammonium chloride | | |
| | (1:1) | | |
| 3 | Chlorohexidine\|Didecyl | 5.19 | 1.69 |
| | dimethyl ammonium | | |
| | chloride\|Alkyl dimethyl | | |
| | ammonium chloride mix | | |
| | (1:1:1) | | |
| 19 | Alkyl dimethyl ammonium | 5.19 | 1.69 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 19

| | | Log Kill | |
|---|---|---|---|
| | | Sample No. 1D | |
| | Klebsiella pneumoniae | 1000 ppm | |
| | Amount of antimicrobial | 500 ppm | 250 ppm |
| 1 | N,N-Didecyl-N-methyl- | 5.13 | 1.13 |
| | poly(oxyethyl) ammonium | | |
| | propionate | | |
| 2 | Chlorohexidine\|Didecyl | 5.13 | 1.13 |
| | dimethyl ammonium chloride | | |
| | (1:1) | | |
| 3 | Chlorohexidine\|Didecyl | 5.13 | 1.13 |
| | dimethyl ammonium | | |
| | chloride\|Alkyl dimethyl | | |
| | ammonium chloride mix | | |
| | (1:1:1) | | |
| 19 | Alkyl dimethyl ammonium | 5.13 | 0.63 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 20

| | | Log Kill | |
|---|---|---|---|
| | | Sample No. 1E | |
| | Klebsiella pneumoniae | 1000 ppm | |
| | Amount of antimicrobial | 500 ppm | 250 ppm |
| 1 | N,N-Didecyl-N-methyl- | 5.00 | 1.25 |
| | poly(oxyethyl) ammonium | | |
| | propionate | | |
| 2 | Chlorohexidine\|Didecyl | 5.00 | 2.50 |
| | dimethyl ammonium chloride | | |
| | (1:1) | | |
| 3 | Chlorohexidine\|Didecyl | 5.00 | 0.75 |
| | dimethyl ammonium | | |
| | chloride\|Alkyl dimethyl | | |
| | ammonium chloride mix | | |
| | (1:1:1) | | |
| 19 | Alkyl dimethyl ammonium | 5.00 | 0.25 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 21

| | | Log Kill | |
|---|---|---|---|
| | | Sample No. 1F | |
| | Klebsiella pneumoniae | 1000 ppm | |
| | Amount of antimicrobial | 500 ppm | 250 ppm |
| 1 | N,N-Didecyl-N-methyl- | 4.94 | 1.69 |
| | poly(oxyethyl) ammonium | | |
| | propionate | | |
| 2 | Chlorohexidine\|Didecyl | 4.94 | 2.19 |
| | dimethyl ammonium chloride | | |
| | (1:1) | | |
| 3 | Chlorohexidine\|Didecyl | 4.94 | 2.94 |
| | dimethyl ammonium | | |
| | chloride\|Alkyl dimethyl | | |
| | ammonium chloride mix | | |
| | (1:1:1) | | |
| 19 | Alkyl dimethyl ammonium | 4.44 | 2.94 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 22

| | | Log Kill | |
|---|---|---|---|
| | | Sample No. 2A | |
| | Klebsiella pneumoniae | 1000 ppm | |
| | Amount of antimicrobial | 500 ppm | 250 ppm |
| 1 | N,N-Didecyl-N-methyl- | 5.00 | 2.25 |
| | poly(oxyethyl) ammonium | | |
| | propionate | | |
| 2 | Chlorohexidine\|Didecyl | 5.00 | 4.50 |
| | dimethyl ammonium chloride | | |
| | (1:1) | | |
| 3 | Chlorohexidine\|Didecyl | 5.00 | 2.50 |
| | dimethyl ammonium | | |
| | chloride\|Alkyl dimethyl | | |
| | ammonium chloride mix | | |
| | (1:1:1) | | |
| 19 | Alkyl dimethyl ammonium | 5.00 | 2.25 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 23

| | | Log Kill | |
|---|---|---|---|
| | | Sample No. 2B | |
| | Klebsiella pneumoniae | 1000 ppm | |
| | Amount of antimicrobial | 500 ppm | 250 ppm |
| 1 | N,N-Didecyl-N-methyl- | 5.13 | 1.88 |
| | poly(oxyethyl) ammonium | | |
| | propionate | | |
| 2 | Chlorohexidine\|Didecyl | 5.13 | 2.63 |
| | dimethyl ammonium chloride | | |
| | (1:1) | | |
| 3 | Chlorohexidine\| Didecyl | 5.13 | 2.63 |
| | dimethyl ammonium | | |
| | chloride\|Alkyl dimethyl | | |
| | ammonium chloride mix | | |
| | (1:1:1) | | |
| 19 | Alkyl dimethyl ammonium | 5.13 | 2.13 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 24

| | | Log Kill | |
|---|---|---|---|
| | | Sample No. 2C | |
| | Klebsiella pneumoniae | 1000 ppm | |
| | Amount of antimicrobial | 500 ppm | 250 ppm |
| 1 | N,N-Didecyl-N-methyl- | 5.19 | 1.44 |
| | poly(oxyethyl) ammonium | | |
| | propionate | | |
| 2 | Chlorohexidine\|Didecyl | 5.19 | 3.19 |
| | dimethyl ammonium chloride | | |
| | (1:1) | | |
| 3 | Chlorohexidine\|Didecyl | 5.19 | 2.44 |
| | dimethyl ammonium | | |
| | chloride\|Alkyl dimethyl | | |
| | ammonium chloride mix | | |
| | (1:1:1) | | |
| 19 | Alkyl dimethyl ammonium | 5.19 | 0.94 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 25

| | | Log Kill | |
|---|---|---|---|
| | | Sample No. 2D | |
| | Klebsiella pneumoniae | 1000 ppm | |
| | Amount of antimicrobial | 500 ppm | 250 ppm |
| 1 | N,N-Didecyl-N-methyl- | 5.38 | 1.88 |
| | poly(oxyethyl) ammonium | | |
| | propionate | | |
| 2 | Chlorohexidine\|Didecyl | 5.38 | 3.38 |
| | dimethyl ammonium chloride | | |
| | (1:1) | | |
| 3 | Chlorohexidine\|Didecyl | 5.38 | 2.63 |
| | dimethyl ammonium | | |
| | chloride\|Alkyl dimethyl | | |
| | ammonium chloride mix | | |
| | (1:1:1) | | |
| 19 | Alkyl dimethyl ammonium | 5.38 | 2.88 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

TABLE No. 26

| | | Log Kill | |
|---|---|---|---|
| | | Sample No. 2E | |
| | Klebsiella pneumoniae | 1000 ppm | |
| | Amount of antimicrobial | 500 ppm | 250 ppm |
| 1 | N,N-Didecyl-N-methyl- | 5.31 | 2.31 |
| | poly(oxyethyl) ammonium | | |
| | propionate | | |
| 2 | Chlorohexidine\|Didecyl | 5.31 | 2.31 |
| | dimethyl ammonium chloride | | |
| | (1:1) | | |
| 3 | Chlorohexidine\|Didecyl | 5.31 | 2.31 |
| | dimethyl ammonium | | |
| | chloride\|Alkyl dimethyl | | |
| | ammonium chloride mix | | |
| | (1:1:1) | | |
| 19 | Alkyl dimethyl ammonium | 5.31 | 2.31 |
| | chloride mix\|Chlorohexidine | | |
| | \|Didecyl dimethyl ammonium | | |
| | chloride\|Alkyl dimethyl benzyl | | |
| | ammonium chloride mix | | |
| | (5:1:1:1) | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A composition comprising:
an antimicrobial agent; and
one or more surfactants combined with the antimicrobial agent, the one or more surfactants comprising:
i) an ethoxylated tertiary amine of the general formula (I): 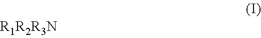
ii) an ethoxylated quaternary amine of the general formula (II): 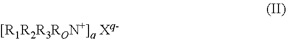
iii) or mixtures thereof,
wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group, or a CH₂OH group and p is 0 or 1,
X is a counterion selected from the group consisting of species generated from a mineral acid or organic acid, and
q is 1, 2, 3 or 4.

2. (canceled)

3. (canceled)

4. A composition as defined in claim 1, wherein p is 0; n and m are an integer from 4 to 30; and Rₐ, R_{b}, R_{c}, R_{d}, Rₑ, R_{f} are H.

5. (canceled)

6. (canceled)

7. (canceled)

8. (canceled)

9. (canceled)

10. A composition as defined in claim 1, wherein the composition comprises from about 5% by weight to about 80% by weight of at least one ethoxylated quaternary amine of the general formula (II) and from about 95% by weight to about 20% by weight of at least one ethoxylated tertiary amine of the general formula (I).

11. (canceled)

12. (canceled)

13. (canceled)

14. A composition as defined in claim 1, wherein the one or more surfactants are present in the composition in relation to the antimicrobial agent at a weight ratio of from about 1:10 to about 5000:1.

15. A composition as defined in claim 1, wherein the antimicrobial agent comprises at least one quaternary ammonium compound having the following structure: 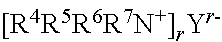
wherein R⁴ is an optionally substituted benzyl group or an optionally substituted alkyl or aryl-substituted alkyl group;
R⁵ and R⁶ are independently optionally substituted alkyl groups;
R⁷ is selected from the group consisting of an optionally substituted alkyl or aryl-substituted alkyl group, benzyl group, and —[(CH₂)₂—O]n-R⁸, wherein n is an integer from 1 to 20 and R⁸ is selected from the group consisting of hydrogen, phenyl, and alkyl-substituted phenyl groups;
Y— is a chlorine ion, bromine ion, phosphate, carbonate, bicarbonate, acetate, ethosulfate, sulfate, propionate, or nitrate; and
r is 1, 2 or 3.

16. A composition as defined in claim 15, wherein the at least one quaternary ammonium compound comprises an alkyl dimethyl benzyl ammonium chloride.

17. A composition as defined in claim 15, wherein the at least one quaternary ammonium compound comprises at least one dimethyl dialkyl ammonium chloride.

18. A composition as defined in claim 15, wherein the least one quaternary ammonium compound comprises didecyl dimethyl ammonium chloride.

19. A composition as defined in claim 15, wherein wherein the least one quaternary ammonium compound comprises an N,N-dialkyl-N,N-dimethylammonium carbonate and/or N,N-dialkyl-N,N-dimethylammonium bicarbonate.

20. A composition as defined in claim 15, wherein the at least one quaternary ammonium compound comprises N,N-didecyl-N-methyl-poly(oxyethyl) ammonium propionate.

21. (canceled)

22. A composition as defined in claim 15, wherein the at least one quaternary ammonium compound comprises tetradecane dimethyl benzyl ammonium chloride, dodecane dimethyl benzyl ammonium chloride, hexadecane dimethyl benzyl ammonium chloride, or a trimethylhexadecyl ammonium compound.

23. (canceled)

24. A composition as defined in claim 15, wherein the one or more surfactants are present in the composition in an amount of from about 10 ppm to about 5000 ppm, and wherein the antimicrobial agent is present in the composition in an amount from about 1 ppm to about 500 ppm.

25. (canceled)

26. (canceled)

27. A composition as defined in claim 1, wherein the antimicrobial agent comprises chlorhexidine, a tertiary amine or mixtures thereof.

28. A composition as defined in claim 15, wherein the composition contains a second antimicrobial agent.

29. A composition as defined in claim 28, wherein the second antimicrobial agent comprises chlorhexidine or a tertiary amine.

30. (canceled)

31. (canceled)

32. (canceled)

33. (canceled)

34. (canceled)

35. (canceled)

36. A fabric treatment comprising:
a laundry detergent composition comprising a laundry detergent surfactant combined with one or more surfactants, the one or more surfactants comprising:
i) an ethoxylated tertiary amine of the general formula (I): 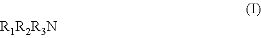
ii) an ethoxylated quaternary amine of the general formula (II): 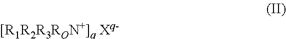
iii) or mixtures thereof,
wherein
R₁ is a linear or branched, saturated or unsaturated, aliphatic or aromatic, substituted or unsubstituted C6 to C24 hydrocarbon or a mixture thereof,
R₂ is a group of formula —(CHRₐ—CHR_{b}—O)ₙH;
R₃ is a group of formula —(CHR_{c}—CHR_{d}—O)ₘH;
n and m are an integer of from 2 to 60, with the proviso that n and m are independently the same or different,
R_{Q} is a C1 to C4 hydrocarbon or is —CHRₑ—CHR_{f}O—(CHRₑ—CHR_{f}O)ₚH
Rₐ, R_{b}, R_{c}, R_{d}, Rₑ, R_{f} are independent of each other and comprise H, a methyl group, or a CH₂OH group and p is 0 or 1,
X is a counterion selected from the group consisting of species generated from a mineral acid or organic acid, and
q is 1, 2, 3 or 4.

37. A fabric treatment as defined in claim 36, wherein the laundry detergent surfactant comprises an alcohol alkoxylate, an alcohol ethoxy sulfate, an amine oxide, a monoethanolamine alkylbenzenesulfonate, a monoethanolamine alkyl benzene sulfonic acid, a monoethanolamine laureth sulfate, a sodium alkylbenzene sulfonate, a sodium lauryl sulfate, or mixtures thereof.

38. A fabric treatment as defined in claim 36, further comprising an antimicrobial agent.

39. A fabric treatment as defined in claim 36, further comprising an enzyme, a perfume, a chelant, a radical scavenger, a soil release polymer, a soil suspension polymer, a whiting agent, a rheology modifier, or mixtures thereof.

40. (canceled)

41. (canceled)

42. (canceled)

43. A fabric treatment as defined in claim 36, wherein the one or more surfactants comprise from about 5% by weight to about 80% by weight of at least one ethoxylated quaternary amine of the general formula (II) and from about 95% by weight to about 20% by weight of at least one ethoxylated tertiary amine of the general formula (I).

44. A fabric treatment as defined in claim 36, wherein the one or more surfactants comprise from about 5% by weight to about 35% by weight of at least one ethoxylated quaternary amine of the general formula (II) and from about 95% by weight to about 65% by weight of at least one ethoxylated tertiary amine of the general formula (I).

45. A fabric treatment as defined in claim 38, wherein the antimicrobial agent comprises at least one quaternary ammonium compound having the following structure: 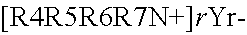
wherein R4 is an optionally substituted benzyl group or an optionally substituted alkyl or aryl-substituted alkyl group;
R5 and R6 are independently optionally substituted alkyl groups;
R7 is selected from the group consisting of an optionally substituted alkyl or aryl-substituted alkyl group, benzyl group, and —[(CH2)2-O]n-R8, wherein n is an integer from 1 to 20 and R8 is selected from the group consisting of hydrogen, phenyl, and alkyl-substituted phenyl groups;
Y— is a chlorine ion, bromine ion, phosphate, carbonate, bicarbonate, acetate, ethosulfate, sulfate, propionate, or nitrate; and
r is 1, 2 or 3.
